(19) United States
(12) Patent Application Publication
(10) Pub. No.: US 2020/0283325 A1
(43) Pub. Date: Sep. 10, 2020

(54) METHODS FOR LINEAR LASER PROCESSING OF TRANSPARENT WORKPIECES USING PULSED LASER BEAM FOCAL LINES AND CHEMICAL ETCHING SOLUTIONS

(71) Applicant: CORNING INCORPORATED, CORNING, NY (US)

(72) Inventors: Roni Daniel Levi, Corning, NY (US); Michael Brian Webb, Lindley, NY (US)

(21) Appl. No.: 16/809,960

(22) Filed: Mar. 5, 2020

Related U.S. Application Data
(60) Provisional application No. 62/813,949, filed on Mar. 5, 2019.

(51) Int. Cl. C03B 33/02; B23K 26/00; B23K 26/064; B23K 26/364; B23K 26/53

(52) U.S. Cl. CPC C03B 33/0222; B23K 26/0006; B23K 26/53; B23K 26/364; B23K 26/064

(57) ABSTRACT

A method for processing a transparent workpiece includes forming a closed contour in the transparent workpiece. The closed contour includes a plurality of defects in the transparent workpiece and has a rectilinear shape. Forming the closed contour includes directing a pulsed laser beam through an aspheric optical element and into the transparent workpiece to generate an induced absorption within the transparent workpiece and produce a defect within the transparent workpiece. Forming the closed contour also includes translating the pulsed laser beam focal line along a closed contour line having the rectilinear shape, thereby laser forming the plurality of defects of the closed contour. In addition, the method for processing the transparent workpiece includes etching the transparent workpiece with a chemical etching solution to separate a portion of the transparent workpiece along the closed contour, thereby forming an aperture extending through the transparent workpiece.

This application claims the benefit of priority under 35 U.S.C. § 119 of U.S. Provisional Application Ser. No. 62/813,949, filed on Mar. 5, 2019, the content of which is relied upon and incorporated herein by reference in its entirety.

### BACKGROUND

### Field

The present specification generally relates to apparatuses and methods for laser processing transparent workpieces, and more particularly, to forming closed contours of defects having a rectilinear shape in transparent workpieces for forming apertures in transparent workpieces.

### Technical Background

The area of laser processing of materials encompasses a wide variety of applications that involve cutting, drilling, milling, welding, melting, etc. of different types of materials. Among these processes, one that is of particular interest is cutting or separating different types of transparent substrates in a process that may be utilized in the production of materials such as glass, sapphire, or fused silica for thin film transistors (TFT), display materials for electronic devices, and acoustic panels for architectural applications.

From process development and cost perspectives there are many opportunities for improvement in cutting and separating glass substrates. It is of great interest to have a faster, cleaner, cheaper, more repeatable, and more reliable method of separating glass substrates than what is currently practiced in the market. Accordingly, a need exists for alternative improved methods for separating glass substrates, for example, to form apertures in glass substrates.

### SUMMARY

According to a first embodiment, a method for processing a transparent workpiece includes forming a closed contour in the transparent workpiece, wherein the closed contour includes a plurality of defects in the transparent workpiece, the closed contour having a rectilinear shape. Forming the closed contour includes directing a pulsed laser beam oriented along a beam pathway and output by a beam source through an aspheric optical element and into the transparent workpiece such that a portion of the pulsed laser beam directed into the transparent workpiece generates an induced absorption within the transparent workpiece, the induced absorption producing a defect within the transparent workpiece, and the portion of the pulsed laser beam directed into the transparent workpiece is a pulsed laser beam focal line which is a quasi-non-diffracting beam. Forming the closed contour also includes translating at least one of the transparent workpiece and the pulsed laser beam focal line relative to each other along a closed contour line having the rectilinear shape, thereby laser forming the plurality of defects of the closed contour along the closed contour line within the transparent workpiece. The method for processing the transparent workpiece further includes etching the transparent workpiece with a chemical etching solution to separate a portion of the transparent workpiece along the closed contour, thereby forming an aperture extending through the transparent workpiece.

A second embodiment includes the method of the first embodiment, wherein the rectilinear shape of the closed contour is a square shape, a rectangular shape, a pentagonal shape, or a hexagonal shape.

A third embodiment includes the method of the first embodiment or the second embodiments, wherein translating at least one of the transparent workpiece and the pulsed laser beam focal line relative to each other along the closed contour line includes translating at least one of the transparent workpiece and the pulsed laser beam focal line in a first linear direction along a first linear path that coincides with a first portion of the closed contour line, thereby laser forming a first portion of defects of the closed contour and translating at least one of the transparent workpiece and the pulsed laser beam focal line in a second linear direction along a second linear path that coincides with a second portion of the closed contour line, thereby laser forming a second portion of defects of the closed contour, wherein the first linear direction is opposite the second linear direction.

A fourth embodiment includes the method of the third embodiment, wherein translating at least one of the transparent workpiece and the pulsed laser beam focal line in the first linear direction along the first linear path laser forms a plurality of first portions of defects of a plurality of closed contours and translating at least one of the transparent workpiece and the pulsed laser beam focal line in the second linear direction along the second linear path laser forms a plurality of second portions of defects of the plurality of closed contours.

A fifth embodiment includes the method of the third embodiment, wherein translating at least one of the transparent workpiece and the pulsed laser beam focal line relative to each other along the closed contour line includes translating at least one of the transparent workpiece and the pulsed laser beam focal line in a third linear direction along a third linear path that coincides with a third portion of the closed contour line, thereby laser forming a third portion of defects of the closed contour and translating at least one of the transparent workpiece and the pulsed laser beam focal line in a fourth linear direction along a fourth linear path that coincides with a fourth portion of the closed contour line, thereby laser forming a fourth portion of defects of the closed contour.

A sixth embodiment includes the method of the fifth embodiment, wherein the fourth linear direction is opposite the third linear direction.

A seventh embodiment includes the method of the fifth embodiment, wherein the first linear path and the second linear path are each orthogonal the third linear path and the fourth linear path.

An eighth embodiment includes the method of the fifth embodiment, wherein the third linear direction is the same as the first linear direction, the fourth linear direction is the same as the second linear direction and the method also includes rotating the transparent workpiece before laser forming the third portion of defects and the fourth portion of defects of the closed contour.

A ninth embodiment includes the method of the fifth embodiment, wherein translating at least one of the transparent workpiece and the pulsed laser beam focal line in the third linear direction along the third linear path laser forms a plurality of third portions of defects of a plurality of closed contours and translating at least one of the transparent workpiece and the pulsed laser beam focal line in the fourth linear direction along the fourth linear path laser forms a plurality of fourth portions of defects of the plurality of closed contours.

A tenth embodiment includes any of the previous embodiments, wherein the aperture has an aperture perimeter having a maximum cross sectional dimension of 100 μm to 10 mm.

A eleventh embodiment includes any of the previous embodiments, wherein the chemical etching solution etches the transparent workpiece at an etching rate of 10 μm/min or less.

A twelfth embodiment includes any of the previous embodiments, wherein etching the transparent workpiece removes 15% or less of a thickness of the transparent workpiece.

A thirteenth embodiment includes any of the previous embodiments, wherein the chemical etching solution includes a chemical etchant that includes hydrofluoric acid, nitric acid, hydrochloric acid, sulfuric acid, or combinations thereof.

The fourteenth embodiment includes any of the previous embodiments, wherein a spacing between adjacent defects is 30 μm or less.

The fifteenth embodiment includes any of the previous embodiments, wherein the quasi-non-diffracting beam includes a wavelength λ, a spot size wₒ, and a Rayleigh range Z_{R} that is greater than

$${F}_{D} \frac{{πw}_{0 ,}^{2}}{λ} ,$$

where F_{D} is a dimensionless divergence factor comprising a value of 10 or greater.

The sixteenth embodiment includes the method of the fifteenth embodiment, wherein the dimensionless divergence factor F_{D} has a value of from 10 to 2000, the pulsed laser beam has a wavelength λ and wherein the transparent workpiece has combined losses due to linear absorption and scattering less than 20%/mm in a beam propagation direction, and the beam source has a pulsed beam source that produces pulse bursts with from 2 sub-pulses per pulse burst to 30 sub-pulses per pulse burst and a pulse burst energy is from 100 μJ to 600 μJ per pulse burst.

The seventeenth embodiment includes any of the previous embodiments, further includes forming a plurality of closed contours in the transparent workpiece using the pulsed laser beam and etching the transparent workpiece with the chemical etching solution to separate portions of the transparent workpiece along the plurality of closed contours, thereby forming a plurality of apertures each extending through the transparent workpiece.

The eighteenth embodiment includes the method of the seventeenth embodiment, wherein adjacent apertures of the plurality of apertures are spaced apart by an aperture spacing distance of from 0.1 to 5 mm.

According to a nineteenth embodiment, a method for processing a transparent workpiece includes forming a linear array of defects in the transparent workpiece, wherein forming the linear array of defects includes directing a pulsed laser beam oriented along a beam pathway and output by a beam source through an aspheric optical element and into the transparent workpiece such that a portion of the pulsed laser beam directed into the transparent workpiece generates an induced absorption within the transparent workpiece, the induced absorption producing a defect within the transparent workpiece, and the portion of the pulsed laser beam directed into the transparent workpiece is a pulsed laser beam focal line which is a quasi-non-diffracting beam. Forming the linear array of defect also includes translating at least one of the transparent workpiece and the pulsed laser beam focal line relative to each other in a first linear direction along a first linear path, thereby laser forming a first defect row of the linear array of defects, translating at least one of the transparent workpiece and the pulsed laser beam focal line relative to each other in a second linear direction along a second linear path, opposite the first linear direction, thereby laser forming a second defect row of the linear array of defects adjacent the first defect row, and translating at least one of the transparent workpiece and the pulsed laser beam focal line relative to each other in the first linear direction along a third linear path, thereby laser forming a third defect row of the linear array of defects adjacent the second defect row. Processing the transparent workpiece also includes etching the transparent workpiece with a chemical etching solution to separate a portion of the transparent workpiece that is co-located with the linear array of defects, thereby forming an aperture extending through the transparent workpiece.

The twentieth embodiment includes the method of the nineteenth embodiment, wherein the linear array of defects includes a perimeter of defects, the perimeter of defects having a square shape, a rectangular shape, a pentagonal shape, or a hexagonal shape.

The twenty-first embodiment includes the method of the nineteenth or twentieth embodiment, wherein each defect row of the linear array of defects are parallel to one another.

The twenty-second embodiment includes the method of any of the nineteenth through the twenty-first embodiment, wherein adjacent defect rows of the linear array of defects are spaced apart by a row spacing distance of 100 μm or less.

The twenty-third embodiment includes the method of any of the nineteenth through the twenty-second embodiments, wherein translating at least one of the transparent workpiece and the pulsed laser beam focal line relative to each other in the first linear direction along the first linear path laser forms a plurality of first defect rows of a plurality of linear arrays of defects, wherein each first defect row is positioned along the first linear path, translating at least one of the transparent workpiece and the pulsed laser beam focal line relative to each other in the second linear direction along the second linear path laser forms a plurality of second defect rows of the plurality of linear arrays of defects, wherein each second defect row is positioned along the second linear path, and translating at least one of the transparent workpiece and the pulsed laser beam focal line relative to each other in the first linear direction along the third linear path laser forms a plurality of third defect rows of the plurality of linear arrays of defects, wherein each third defect row is positioned along the third linear path.

The twenty-fourth embodiment includes the method of any of the nineteenth through the twenty-third embodiments, wherein the quasi-non-diffracting beam has a wavelength λ, a spot size wₒ, and a Rayleigh range Z_{R} that is greater than

$${F}_{D} \frac{π {w}_{0 ,}^{2}}{λ} ,$$

where F_{D} is a dimensionless divergence factor comprising a value of 10 or greater.

The twenty-fifth embodiment includes the method of any of the nineteenth through the twenty-fourth embodiments, further including a plurality of closed contours in the transparent workpiece using the pulsed laser beam and etching the transparent workpiece with the chemical etching solution to separate portions of the transparent workpiece along the plurality of closed contours, thereby forming a plurality of apertures each extending through the transparent workpiece.

The twenty-sixth embodiment includes the method of the twenty-fifth embodiment, wherein adjacent apertures of the plurality of apertures are spaced apart by an aperture spacing distance of from 0.1 to 5 mm.

According to a twenty-seventh embodiment, a transparent workpiece assembly includes a transparent workpiece having a first surface opposite a second surface and an array of apertures extending from the first surface to the second surface. Each of the array of apertures has a rectilinear shape and adjacent apertures of the array of apertures are spaced apart by an aperture spacing distance of from 0.1 mm to 5 mm.

The twenty-eighth embodiment includes the method of the twenty-seventh embodiment, wherein the array of apertures has 50 apertures or more.

The twenty-ninth embodiment includes the method of the twenty-eighth embodiment, wherein the array of apertures has 500 apertures or more.

The thirtieth embodiment includes the method of the twenty-eighth or twenty-ninth embodiment, wherein the transparent workpiece comprises an ion-exchanged glass.

The thirty-first embodiment includes the method of any of the twenty-eighth through the thirtieth embodiment, wherein the transparent workpiece is a first transparent workpiece and the transparent workpiece assembly further includes a second transparent workpiece coupled to the first surface or the second surface of the first transparent workpiece.

The thirty-second embodiment includes the method of the thirty-first embodiment, wherein the second transparent workpiece is thicker than the first transparent workpiece.

Additional features and advantages of the processes and systems described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts the laser formation of a closed contour of defects comprising a rectilinear shape in a transparent workpiece, according to one or more embodiments described herein;

FIG. 1B schematically depicts an example pulsed laser beam focal line during processing of a transparent workpiece, according to one or more embodiments described herein;

FIG. 2 schematically depicts an optical assembly for pulsed laser processing, according to one or more embodiments described herein;

FIG. 3A graphically depicts the relative intensity of laser pulses within an exemplary pulse burst vs. time, according to one or more embodiments described herein, according to one or more embodiments described herein;

FIG. 3B graphically depicts relative intensity of laser pulses vs. time within another exemplary pulse burst, according to one or more embodiments described herein;

FIG. 4A schematically depicts a plurality of closed contour lines on a surface of a transparent workpiece, each comprising a rectilinear shape, according to one or more or more embodiments described herein;

FIG. 4B schematically depicts a plurality of linear paths coincident with portions of the closed contour lines of FIG. 4A, according to one or more embodiments described herein;

FIG. 4C schematically depicts a plurality of contours of defects formed along the plurality of closed contour lines of FIG. 4A, according to one or more embodiments described herein;

FIG. 4D schematically depicts a plurality of linear paths coincident with parallel portions of the closed contour lines of FIG. 4A, according to one or more embodiments described herein;

FIG. 4E schematically depicts a plurality of linear paths coincident with other parallel portions of the closed contour lines of FIG. 4A, according to one or more embodiments described herein;

FIG. 5A schematically depicts the laser formation of a linear array of defects in a transparent workpiece, according to one or more embodiments described herein;

FIG. 5B schematically depicts a plurality of linear array lines on a surface of a transparent workpiece, according to one or more or more embodiments described herein;

FIG. 5C schematically depicts a plurality of linear paths coincident with linear array lines of the plurality of linear array lines of FIG. 5B, according to one or more embodiments described herein;

FIG. 5D schematically depicts a plurality of linear arrays of defects formed along the plurality of linear array lines of FIG. 5B, according to one or more embodiments described herein;

FIG. 6A schematically depicts an example transparent workpiece comprising a plurality of closed contour lines according to one or more embodiments described herein;

FIG. 6B schematically depicts the example transparent workpiece of FIG. 6A positioned in a chemical etching bath, according to one or more embodiments described herein;

FIG. 6C schematically depicts the example transparent workpiece of FIGS. 6A and 6B after chemical etching such that the transparent workpiece comprises a plurality of apertures, according to one or more embodiments described herein;

FIG. 6D schematically depicts a detailed section of the chemical etching bath of FIG. 6B, according to one or more embodiments shown and described herein;

FIG. 7 depicts an example transparent workpiece having a closed contour of defects comprising a rectilinear shape formed therein, according to one or more embodiments shown and described herein;

FIG. 8 depicts an example transparent workpiece having a linear array of defects formed therein, according to one or more embodiments shown and described herein; and

FIG. 9 depicted an example transparent workpiece having a plurality of apertures, according to one or more embodiments shown and described herein.

### DETAILED DESCRIPTION

Reference will now be made in detail to embodiments of processes for laser processing transparent workpieces, such as glass workpieces, examples of which are illustrated in the accompanying drawings. Whenever possible, the same reference numerals will be used throughout the drawings to refer to the same or like parts. According to one or more embodiments described herein, a transparent workpiece may be laser processed to form a closed contour in the transparent workpiece comprising a series of defects that define a desired perimeter of one or more apertures through the transparent workpiece. In particular, in some embodiments, the closed contours of defects described herein comprise a rectilinear shape. According to one embodiment, a pulsed laser outputs a pulsed laser beam, which propagates through an aspheric optical element such that the pulsed laser beam projects a pulsed laser beam focal line that is directed into the transparent workpiece. The pulsed laser beam focal line may be utilized to create a series of defects in the transparent workpiece thereby defining the closed contour. The rectilinear shape of the closed contour allows the closed contour to be laser formed with linear passes of the pulsed laser beam along a surface of the transparent workpiece, increasing the speed and efficiency that multiple closed contours may be formed when compared to curvilinear (e.g., rounded) closed contours.

In some embodiments, the process may further include separating the transparent workpiece along the rectilinear closed contour, for example, by chemical etching, thereby forming an aperture through the transparent workpiece. A rectilinear closed contour of defects may be formed into an aperture via chemical etching much faster than a single defect may be chemically etched (and enlarged) into an aperture of the same maximum cross-sectional dimension. A faster etching process means that less material is removed from the thickness of the transparent workpiece, facilitating the formation of thicker transparent workpieces with apertures. While the embodiments of processing a transparent workpiece to form one or more apertures extending through the transparent workpiece may be used in a variety of contexts, the present embodiments are particularly useful for forming apertures in transparent workpieces to create sound absorbing glass panels. Various embodiments of methods and apparatuses for processing a transparent workpiece will be described herein with specific reference to the appended drawings.

As used herein, “laser processing” comprises directing a laser beam onto and/or into a transparent workpiece. In some embodiments, laser processing further comprises translating the laser beam relative to the transparent workpiece, for example, along a contour line or other pathway. Examples of laser processing include using a laser beam (e.g., a pulsed laser beam) to form a contour comprising a series of defects that extend into the transparent workpiece In some embodiments, additional, non-laser steps, such as chemical etching may be utilized to separate the transparent workpieces along one or more desired lines of separation.

As used herein, “beam spot” refers to a cross section of a laser beam (e.g., a beam cross section) at the impingement surface, i.e., the surface of a transparent workpiece in closest proximity to the laser optics. The beam spot is the cross-section at the point of first contact with a workpiece (e.g., a transparent workpiece). In the embodiments described herein, the beam spot is sometimes referred to as being “axisymmetric” or “non-axisymmetric.” As used herein, axisymmetric refers to a shape that is symmetric, or appears the same, for any arbitrary rotation angle made about a central axis, and “non-axisymmetric” refers to a shape that is not symmetric for any arbitrary rotation angle made about a central axis. The rotation axis (e.g., the central axis) is most often taken as being the propagation axis of the laser beam, which is the axis extending in the beam propagation direction, which is referred to herein as the z-direction.

As used herein, “upstream” and “downstream” refer to the relative position of two locations or components along a beam pathway with respect to a beam source. For example, a first component is upstream from a second component if the first component is closer to the beam source along the path traversed by the laser beam than the second component.

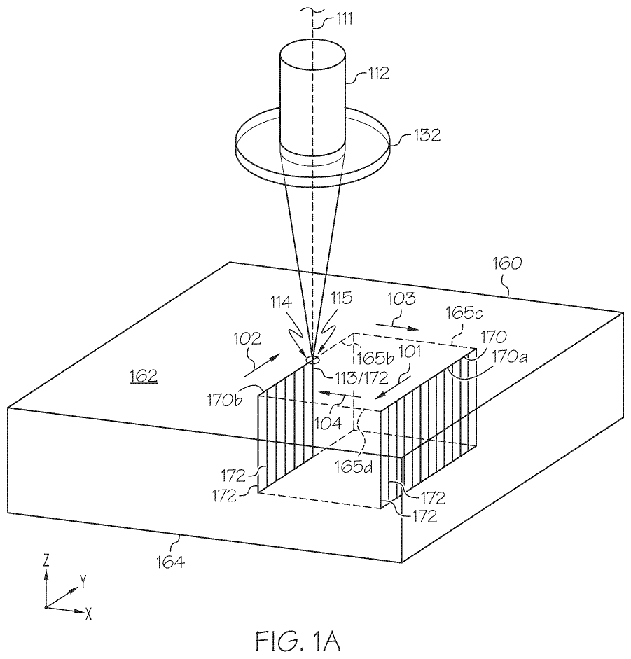

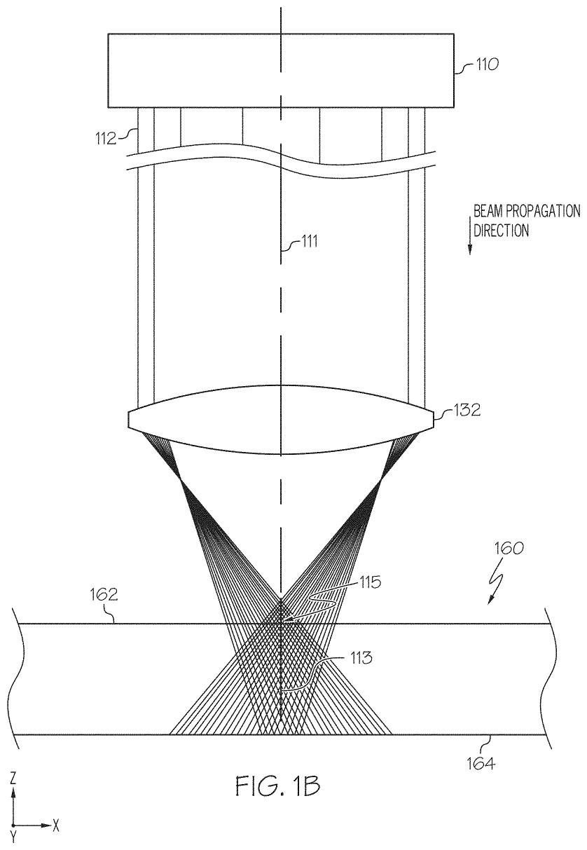

As used herein, “laser beam focal line,” refers to pattern of interacting (e.g., crossing) light rays of a laser beam that form an elongated focused region. The elongated focus region is the region of maximum intensity of the laser beam focal line and is formed by light rays that interact (e.g., cross) to form a plurality of tightly spaced focal points which collectively form the laser beam focal line. The laser beam focal lines described herein are formed using a quasi-non-diffracting beam, mathematically defined in detail below. A schematic depiction of these tightly spaced focal points is shown in FIG. 1B.

As used herein, “contour line,” denotes a linear, angled, polygonal or curved line on a surface of a transparent workpiece that defines the path traversed by the laser beam as it is moved within the plane of the workpiece to create a corresponding contour. The contour line represents a path of desired separation along a surface of the transparent workpiece. In some embodiments, the contour line is a closed contour line and defines the entire desired perimeter of an aperture that may be formed in the transparent workpiece.

As used herein, “contour,” refers to a set of defects in a transparent workpiece formed by translating a laser along a contour line. As used herein, a contour refers to a virtual two dimensional shape or path in or on a substrate. Thus, while a contour itself is a virtual shape, the contour may be manifest, for example, by propagating a crack along the plurality of defects. A contour may be formed by creating a plurality of defects in the transparent workpiece using various techniques along the contour line, for example by directed a pulsed laser beam at successive points along the contour line. The contour is a “closed contour” when formed along a closed contour line. The closed contour defines a desired aperture perimeter along which material of the transparent workpiece may be removed to form one or more apertures extending through the transparent workpiece upon exposure to the appropriate processing conditions. While not intending to be limited by theory, the chemical etching solution may remove material of the transparent workpiece at and immediately surrounding each defect, thereby enlarging each defect such that voids formed from adjacent defects overlap, ultimately leading to separation of the transparent workpiece along the closed contour and formation of the aperture extending through the transparent workpiece.

As used herein, a “defect” refers to a region of modified material (e.g., a region of modified refractive index relative to the bulk material), void space, crack, scratch, flaw, hole, perforation or other deformities in the transparent workpiece. These defects may be referred to, in various embodiments herein, as defect lines or damage tracks. A defect is formed by a laser beam directed onto a single position of the transparent workpiece, for a single laser pulse, a pulse burst of sub-pulses, or multiple pulses at the same location. Translating the laser along the contour line results in multiple defects that form a contour.

The phrase “transparent workpiece,” as used herein, means a workpiece formed from glass, glass-ceramic or other material which is transparent, where the term “transparent,” as used herein, means that the material has an optical absorption of less than 20% per mm of material depth, such as less than 10% per mm of material depth for the specified pulsed laser wavelength, or such as less than 1% per mm of material depth for the specified pulsed laser wavelength. Unless otherwise specified, the material has an optical absorption of less than 20% per mm of material depth. The transparent workpiece may have a depth (e.g., thickness) of from 50 microns (μm) to 10 mm (such as from 100 μm to 5 mm, or from 0.5 mm to 3 mm). Example thicknesses include 0.5 mm, 0.7 mm, 1 mm, 1.6 mm, 2 mm, and 3 mm. Transparent workpieces may comprise glass workpieces formed from glass compositions, such as borosilicate glass, soda-lime glass, aluminosilicate glass, alkali aluminosilicate, alkaline earth aluminosilicate glass, alkaline earth boro-aluminosilicate glass, fused silica, or crystalline materials such as sapphire, silicon, gallium arsenide, or combinations thereof. In some embodiments the transparent workpiece may be strengthened via thermal tempering before or after laser processing the transparent workpiece. In some embodiments, the glass may be ion-exchangeable, such that the glass composition can undergo ion-exchange for glass strengthening before or after laser processing the transparent workpiece. For example, the transparent workpiece may comprise ion exchanged and ion exchangeable glass, such as Corning Gorilla® Glass available from Corning Incorporated of Corning, N.Y. (e.g., code 2318, code 2319, and code 2320). Further, these ion exchanged glasses may have coefficients of thermal expansion (CTE) of from 6 ppm/° C. to 10 ppm/° C. Other example transparent workpieces may comprise EAGLE XG® and CORNING LOTUS' available from Corning Incorporated of Corning, N.Y. Moreover, the transparent workpiece may comprise other components which are transparent to the wavelength of the laser, for example, crystals such as sapphire or zinc selenide.

In an ion exchange process, ions in a surface layer of the transparent workpiece are replaced by larger ions having the same valence or oxidation state, for example, by partially or fully submerging the transparent workpiece in an ion exchange bath. Replacing smaller ions with larger ions causes a layer of compressive stress to extend from one or more surfaces of the transparent workpiece to a certain depth within the transparent workpiece, referred to as the depth of layer. The compressive stresses are balanced by a layer of tensile stresses (referred to as central tension) such that the net stress in the glass sheet is zero. The formation of compressive stresses at the surface of the glass sheet makes the glass strong and resistant to mechanical damage and, as such, mitigates catastrophic failure of the glass sheet for flaws which do not extend through the depth of layer. In some embodiments, smaller sodium ions in the surface layer of the transparent workpiece are exchanged with larger potassium ions. In some embodiments, the ions in the surface layer and the larger ions are monovalent alkali metal cations, such as Li+(when present in the glass), Na+, K+, Rb+, and Cs+. Alternatively, monovalent cations in the surface layer may be replaced with monovalent cations other than alkali metal cations, such as Ag+, Tl+, Cu+, or the like.

As used herein, the term “quasi-non-diffracting beam” is used to describe a laser beam having low beam divergence as mathematically described below. In particular, the laser beam used to form a contour of defects in the embodiments described herein. The laser beam has an intensity distribution I(X,Y,Z), where Z is the beam propagation direction of the laser beam, and X and Y are directions orthogonal to the direction of propagation, as depicted in the figures. The X-direction and Y-direction may also be referred to as cross-sectional directions and the X-Y plane may be referred to as a cross-sectional plane. The intensity distribution of the laser beam in a cross-sectional plane may be referred to as a cross-sectional intensity distribution.

The quasi-non-diffracting property (or characteristic) of the laser beam at a beam spot or other cross section may be formed by impinging a laser beam (such as a Gaussian beam) into and/or thorough one or more aspheric optical elements, such as one or more axicons. Example quasi non-diffracting beams include Gauss-Bessel beams and Bessel beams. Furthermore, optical assemblies that include a phase altering optical element are described in more detail below.

Without intending to be limited by theory, beam divergence refers to the rate of enlargement of the beam cross section in the direction of beam propagation (i.e., the Z direction). One example beam cross section discussed herein is a beam spot 114 of a pulsed laser beam 112 projected onto a transparent workpiece 160 (FIG. 1A). Diffraction is one factor that leads to divergence of laser beams. Other factors include focusing or defocusing caused by the optical systems forming the laser beams or refraction and scattering at interfaces. Laser beams for forming the defects of the contours may form laser beam focal lines with low divergence and weak diffraction. The divergence of the laser beam is characterized by the Rayleigh range Z_{R}, which is related to the variance σ² of the intensity distribution and beam propagation factor M² of the laser beam. In the discussion that follows, formulas will be presented using a Cartesian coordinate system. Corresponding expressions for other coordinate systems are obtainable using mathematical techniques known to those of skill in the art. Additional information on beam divergence can be found in the articles entitled “New Developments in Laser Resonators” by A. E. Siegman in SPIE Symposium Series Vol. 1224, p. 2 (1990) and “M² factor of Bessel-Gauss beams” by R. Borghi and M. Santarsiero in Optics Letters, Vol. 22(5), 262 (1997), the disclosures of which are incorporated herein by reference in their entirety. Additional information can also be found in the international standards ISO 11146-1:2005(E) entitled “Lasers and laser-related equipment—Test methods for laser beam widths, divergence angles and beam propagation ratios—Part 1: Stigmatic and simple astigmatic beams”, ISO 11146-2:2005(E) entitled “Lasers and laser-related equipment—Test methods for laser beam widths, divergence angles and beam propagation ratios—Part 2: General astigmatic beams”, and ISO 11146-3:2004(E) entitled “Lasers and laser-related equipment—Test methods for laser beam widths, divergence angles and beam propagation ratios—Part 3: Intrinsic and geometrical laser beam classification, propagation and details of test methods”, the disclosures of which are incorporated herein by reference in their entirety.

The spatial coordinates of the centroid of the intensity profile of the laser beam having a time-averaged intensity profile I(x, y, z) are given by the following expressions:

$$\begin{matrix}\overline{x} ( z ) = \frac{{{\int }_{- ∞}}^{∞} {{\int }_{- ∞}}^{∞} xI ( x , y , z ) dxdy}{{{\int }_{- ∞}}^{∞} {{\int }_{- ∞}}^{∞} I ( x , y , z ) dxdy} & ( 1 ) \\ \overline{y} ( z ) = \frac{{{\int }_{- ∞}}^{∞} {{\int }_{- ∞}}^{∞} yI ( x , y , z ) dxdy}{{{\int }_{- ∞}}^{∞} {{\int }_{- ∞}}^{∞} I ( x , y , z ) dxdy} & ( 2 )\end{matrix}$$

These are also known as the first moments of the Wigner distribution and are described in Section 3.5 of ISO 11146-2:2005(E). Their measurement is described in Section 7 of ISO 11146-2:2005(E).

Variance is a measure of the width, in the cross-sectional (X-Y) plane, of the intensity distribution of the laser beam as a function of position z in the direction of beam propagation. For an arbitrary laser beam, variance in the X-direction may differ from variance in the Y-direction. We let σₓ²(z) and σ_{y}²(z) represent the variances in the X-direction and Y-direction, respectively. Of particular interest are the variances in the near field and far field limits. We let σ₀ₓ²(z) and σ_{0y}² (z) represent variances in the X-direction and Y-direction, respectively, in the near field limit, and we let σ_{∞x}²(z) and σ_{∞y}²(z) represent variances in the X-direction and Y-direction, respectively, in the far field limit. For a laser beam having a time-averaged intensity profile I(x, y, z) with Fourier transform Ĩ(vₓ,v_{y}) (where vₓ and v_{y} are spatial frequencies in the X-direction and Y-direction, respectively), the near field and far field variances in the X-direction and Y-direction are given by the following expressions:

$$\begin{matrix}{σ}_{0 x}^{2} ( z ) = \frac{{{\int }_{- ∞}}^{∞} {{\int }_{- ∞}}^{∞} {x}^{2} I ( x , y , z ) dxdy}{{{\int }_{- ∞}}^{∞} {{\int }_{- ∞}}^{∞} I ( x , y , z ) dxdy} & ( 3 ) \\ {σ}_{0 y}^{2} ( z ) = \frac{{{\int }_{- ∞}}^{∞} {{\int }_{- ∞}}^{∞} {y}^{2} I ( x , y , z ) dxdy}{{{\int }_{- ∞}}^{∞} {{\int }_{- ∞}}^{∞} I ( x , y , z ) dxdy} & ( 4 ) \\ {σ}_{∞ x}^{2} = \frac{{{\int }_{- ∞}}^{∞} {{\int }_{- ∞}}^{∞} {v}_{x}^{2} \tilde{I} ( {v}_{x} , {v}_{y} ) {dv}_{x} {dv}_{y}}{{{\int }_{- ∞}}^{∞} {{\int }_{- ∞}}^{∞} \tilde{I} ( {v}_{x} , {v}_{y} ) {dv}_{x} {dv}_{y}} & ( 5 ) \\ {σ}_{∞ y}^{2} = \frac{{{\int }_{- ∞}}^{∞} {{\int }_{- ∞}}^{∞} {v}_{y}^{2} \tilde{I} ( {v}_{x} , {v}_{y} ) {dv}_{x} {dv}_{y}}{{{\int }_{- ∞}}^{∞} {{\int }_{- ∞}}^{∞} \tilde{I} ( {v}_{x} , {v}_{y} ) {dv}_{x} {dv}_{y}} & ( 6 )\end{matrix}$$

The variance quantities σ₀ₓ²(z), σ_{0y}²(z), σ_{∞x}², and σ_{∞x}², are also known as the diagonal elements of the Wigner distribution (see ISO 11146-2:2005(E)). These variances can be quantified for an experimental laser beam using the measurement techniques described in Section 7 of ISO 11146-2:2005(E). In brief, the measurement uses a linear unsaturated pixelated detector to measure I(x, y) over a finite spatial region that approximates the infinite integration area of the integral equations which define the variances and the centroid coordinates. The appropriate extent of the measurement area, background subtraction and the detector pixel resolution are determined by the convergence of an iterative measurement procedure described in Section 7 of ISO 11146-2:2005(E). The numerical values of the expressions given by equations 1-6 are calculated numerically from the array of intensity values as measured by the pixelated detector.

Through the Fourier transform relationship between the transverse amplitude profile ũ(x, y, z) for an arbitrary optical beam (where I(x, y, z)≡|ũ(x, y, z)|²) and the angular spectrum (often referred to as the spatial frequency distribution) \tilde{P}(vₓ, v_{y},z) for an arbitrary optical beam (where Ĩ(vₓ, v_{y})≡|\tilde{P}(vₓ, v_{y}, z)|²), it can be shown that:

σₓ²(z)=σ₀ₓ²(z₀ₓ)+λ²σ_{∞x}²(z−z₀ₓ)² (7)

σ_{y}²(z)=σ_{0y}²(z_{0y})+λ²σ_{∞y}²(z−z_{0y})² (8)

In equations (7) and (8), σ₀ₓ²(zₒₓ) and σ_{0y}²(z_{0y}) are minimum values of σ₀ₓ²(z) and σ_{0y}²(z), which occur at waist positions z₀ₓ and z_{0y} in the x-direction and y-direction, respectively, and λ is the wavelength of the laser beam. Equations (7) and (8) indicate that σₓ²(z) and σ_{y}²(z) increase quadratically with z in either direction from the minimum values associated with the waist position of the laser beam (e.g., the waist portion of the laser beam focal line). Further, in the embodiments described herein comprising a beam spot 114 that is axisymmetric and thereby comprises an axisymmetric intensity distribution I(x,y), σₓ²(z)=σ_{y}²(z) and in the embodiments described herein comprising a beam spot 114 that is non-axisymmetric and thereby comprises a non-axisymmetric intensity distribution I(x,y), σₓ²(z)=σ_{y}²(z), i.e., σₓ²(z)<σ_{y}²(z) or σₓ²(z)>σ_{y}²(z).

Equations (7) and (8) can be rewritten in terms of a beam propagation factor M², where separate beam propagations factors Mₓ² and M_{y}² for the x-direction and the y-direction are defined as:

Mₓ²≡4πσ₀ₓσ_{∞x} (9)

M_{y}²≡4πσ_{0y}σ_{∞y} (10)

Rearrangement of Equations (9) and (10) and substitution into Equations (7) and (8) yields:

$$\begin{matrix}{σ}_{x}^{2} ( z ) = {σ}_{0 x}^{2} ( {z}_{0 x} ) + \frac{{λ}^{2} {M}_{x}^{4}}{{( 4 {πσ}_{0 x} )}^{2}} {( z - {z}_{0 x} )}^{2} & ( 11 ) \\ {σ}_{y}^{2} ( z ) = {σ}_{0 y}^{2} ( {z}_{0 y} ) + \frac{{λ}^{2} {M}_{y}^{4}}{{( 4 {πσ}_{0 y} )}^{2}} {( z - {z}_{0 y} )}^{2} & ( 12 )\end{matrix}$$

which can be rewritten as:

$$\begin{matrix}{σ}_{x}^{2} ( z ) = {σ}_{0 x}^{2} ( {z}_{0 x} ) [ 1 + \frac{{( z - {z}_{0 x} )}^{2}}{{Z}_{Rx}^{2}} ] & ( 13 ) \\ {σ}_{y}^{2} ( z ) = {σ}_{0 y}^{2} ( {z}_{0 y} ) [ 1 + \frac{{( z - {z}_{0 y} )}^{2}}{{Z}_{Ry}^{2}} ] & ( 14 )\end{matrix}$$

where the Rayleigh ranges Z_{Rx} and Z_{Ry} in the x-direction and y-direction, respectively, are given by:

$$\begin{matrix}{Z}_{Rx} = \frac{4 {πσ}_{0 x}^{2}}{{M}_{x}^{2} λ} & ( 15 ) \\ {Z}_{Ry} = \frac{4 {πσ}_{0 y}^{2}}{{M}_{y}^{2} λ} & ( 16 )\end{matrix}$$

The Rayleigh range corresponds to the distance (relative to the position of the beam waist as defined in Section 3.12 of ISO 11146-1:2005(E)) over which the variance of the laser beam doubles (relative to the variance at the position of the beam waist) and is a measure of the divergence of the cross sectional area of the laser beam. Further, in the embodiments described herein comprising a beam spot 114 that is axisymmetric and thereby comprises an axisymmetric intensity distribution I(x,y), Z_{Rx}=Z_{Ry} and in the embodiments described herein comprising a beam spot 114 that is non-axisymmetric and thereby comprises a non-axisymmetric intensity distribution I(x,y), Z_{Rx}≠ Z_{Ry}, i.e., Z_{Rx}<Z_{Ry} or Z_{Rx}>Z_{Ry}. The Rayleigh range can also be observed as the distance along the beam axis at which the optical intensity decays to one half of its value observed at the beam waist location (location of maximum intensity). Laser beams with large Rayleigh ranges have low divergence and expand more slowly with distance in the beam propagation direction than laser beams with small Rayleigh ranges.

The formulas above can be applied to any laser beam (not just Gaussian beams) by using the intensity profile I(x, y, z) that describes the laser beam. In the case of the TEM₀₀ mode of a Gaussian beam, the intensity profile is given by:

$$I ( x , y ) = \frac{\sqrt{π}}{2} {w}_{o} {e}^{\frac{- 2 ( {x}^{2} + {y}^{2} )}{{w}_{o}^{2}}} \qquad ( 17 )$$

where wₒ is the radius (defined as the radius at which beam intensity decreases to 1/e² of the peak beam intensity of the beam at a beam waist position zₒ. From Equation (17) and the above formulas, we obtain the following results for a TEM₀₀ Gaussian beam:

$$\begin{matrix}{σ}_{0 x}^{2} = {σ}_{0 y}^{2} = \frac{{w}_{o}^{2}}{4} & ( 18 ) \\ {σ}_{∞ x}^{2} = {σ}_{∞ y}^{2} = \frac{1}{4 {π}^{2} {w}_{o}^{2}} & ( 19 ) \\ {M}_{x}^{2} = 4 {πσ}_{0 x} {σ}_{∞ x} = 1 & ( 20 ) \\ {M}_{y}^{2} = 4 {πσ}_{0 y} {σ}_{∞ y} = 1 & ( 21 ) \\ {Z}_{Rx} = \frac{4 {πσ}_{0 x}^{2}}{{M}_{x}^{2} λ} = \frac{π {w}_{0}^{2}}{λ} & ( 22 ) \\ {Z}_{Ry} = \frac{4 {πσ}_{0 y}^{2}}{{M}_{y}^{2} λ} = \frac{π {w}_{0}^{2}}{λ} & ( 23 )\end{matrix}$$

$${w}^{2} ( z ) = {w}_{0}^{2} + \frac{{λ}^{2}}{{( π {w}_{0} )}^{2}} {( z - {z}_{0} )}^{2} = {w}_{0}^{2} [ 1 + \frac{{( z - {z}_{0} )}^{2}}{{Z}_{R}^{2}} ] \qquad ( 24 )$$

where Z_{R}=Z_{Rx}=Z_{Ry}. For Gaussian beams, it is further noted that M²=Mₓ²=M_{y}²=1.

Beam cross section is characterized by shape and dimensions. The dimensions of the beam cross section are characterized by a spot size of the beam. For a Gaussian beam, spot size is frequently defined as the radial extent at which the intensity of the beam decreases to 1/e² of its maximum value, denoted in Equation (17) as w₀. The maximum intensity of a Gaussian beam occurs at the center (x=0 and y=0 (Cartesian) or r=0 (cylindrical)) of the intensity distribution and radial extent used to determine spot size is measured relative to the center.

Beams with axisymmetric (i.e. rotationally symmetric around the beam propagation axis Z) cross sections can be characterized by a single dimension or spot size that is measured at the beam waist location as specified in Section 3.12 of ISO 11146-1:2005(E). For a Gaussian beam, Equation (17) shows that spot size is equal to w₀, which from Equation (18) corresponds to 2σ₀ₓ or 2σ_{0y}. For an axisymmetric beam having an axisymmetric cross section, such as a circular cross section, σ₀ₓ=σ_{0y}. Thus, for axisymmetric beams, the cross section dimension may be characterized with a single spot size parameter, where w₀=2σ₀. Spot size can be similarly defined for non-axisymmetric beam cross sections where, unlike an axisymmetric beam, σ₀ₓ≠σ_{0y}. Thus, when the spot size of the beam is non-axisymmetric, it is necessary to characterize the cross-sectional dimensions of a non-axisymmetric beam with two spot size parameters: wₒₓ and w_{oy} in the x-direction and y-direction, respectively, where

wₒₓ=2σ₀ₓ (25)

w_{oy}=2σ_{0y} (26)

Further, the lack of axial (i.e. arbitrary rotation angle) symmetry for a non-axisymmetric beam means that the results of a calculation of values of σ₀ₓ and σ_{0y} will depend on the choice of orientation of the X-axis and Y-axis. ISO 11146-1:2005(E) refers to these reference axes as the principal axes of the power density distribution (Section 3.3-3.5) and in the following discussion we will assume that the X and Y axes are aligned with these principal axes. Further, an angle π about which the X-axis and Y-axis may be rotated in the cross-sectional plane (e.g., an angle of the X-axis and Y-axis relative to reference positions for the X-axis and Y-axis, respectively) may be used to define minimum (w_{o,min}) and maximum values (w_{o,max}) of the spot size parameters for a non-axisymmetric beam:

w_{o,min}=2σ_{0,min} (27)

w_{o,max}=2σ_{0,max} (28)

where 2σ_{0,min}=2σ₀ₓ(ϕ_{min,x})=2σ_{0y}(ϕ_{min,y}) and 2σ_{0,max}=2σ₀ₓ(ϕ_{max,x})=2σ_{0y}(ϕ_{max,y}) The magnitude of the axial asymmetry of the beam cross section can be quantified by the aspect ratio, where the aspect ratio is defined as the ratio of w_{o,max} to w_{o,min}. An axisymmetric beam cross section has an aspect ratio of 1.0, while elliptical and other non-axisymmetric beam cross sections have aspect ratios greater than 1.0, for example, greater than 1.1, greater than 1.2, greater than 1.3, greater than 1.4, greater than 1.5, greater than 1.6, greater than 1.7, greater than 1.8, greater than 1.9, greater than 2.0, greater than 3.0, greater than 5.0, greater than 10.0, or the like

To promote uniformity of defects in the beam propagation direction (e.g. depth dimension of the transparent workpiece), a laser beam having low divergence may be used. In one or more embodiments, pulsed laser beams 112 having low divergence may be utilized for forming defects. As noted above, divergence can be characterized by the Rayleigh range. For non-axisymmetric beams, Rayleigh ranges for the principal axes X and Y are defined by Equations (15) and (16) for the X-direction and Y-direction, respectively, where it can be shown that for any real beam, Mₓ²>1 and M_{y}²>1 and where σ₀ₓ² and σ_{0y}² are determined by the intensity distribution of the laser beam. For symmetric beams, Rayleigh range is the same in the X-direction and Y-direction and is expressed by Equation (22) or Equation (23). Low divergence correlates with large values of the Rayleigh range and weak diffraction of the laser beam.

Beams with Gaussian intensity profiles may be less preferred for laser processing to form defects because, when focused to small enough spot sizes (such as spot sizes in the range of microns, such as 1-5 μm or 1-10 μm) to enable available laser pulse energies to modify materials such as glass, they are highly diffracting and diverge significantly over short propagation distances. To achieve low divergence, it is desirable to control or optimize the intensity distribution of the pulsed laser beam to reduce diffraction. Pulsed laser beams may be non-diffracting or weakly diffracting. Weakly diffracting laser beams include quasi-non-diffracting laser beams. Representative weakly diffracting laser beams include Bessel beams, Gauss-Bessel beams, Airy beams, Weber beams, and Mathieu beams.

For non-axisymmetric beams, the Rayleigh ranges Z_{Rx} and Z_{Ry} are unequal. Equations (15) and (16) indicate that Z_{Rx} and Z_{Ry} depend on σ₀ₓ and σ_{0y}, respectively, and above we noted that the values of σ₀ₓ and σ_{0y} depend on the orientation of the X-axis and Y-axis. The values of Z_{Rx} and Z_{Ry} will accordingly vary, and each will have a minimum value and a maximum value that correspond to the principal axes, with the minimum value of Z_{Rx} being denoted as and the minimum value of of Z_{Ry} being denoted for an arbitrary beam profile and Z_{Ry,min} can be shown to be given by

$$\begin{matrix}{Z}_{Rx , min} = \frac{4 {πσ}_{0 , min}^{2}}{{M}_{x}^{2} λ} & ( 29 ) \\ and & \\ {Z}_{Ry , min} = \frac{4 {πσ}_{0 , min}^{2}}{{M}_{y}^{2} λ} & ( 30 )\end{matrix}$$

Since divergence of the laser beam occurs over a shorter distance in the direction having the smallest Rayleigh range, the intensity distribution of the laser beam used to form defects may be controlled so that the minimum values of Z_{Rx} and Z_{Ry} (or for axisymmetric beams, the value of Z_{R}) are as large as possible. Since the minimum value Z_{Rx,min} of Z_{Rx} and the minimum value Z_{Ry,min} of Z_{Ry} differ for a non-axisymmetric beam, a pulsed laser beam 112 may be used with an intensity distribution that makes the smaller of Z_{Rx,min} and Z_{Ry,min} as large as possible when forming damage regions.

In different embodiments, the smaller of Z_{Rx,min} and Z_{Ry,min} (or for axisymmetric beams, the value of Z_{R}) is greater than or equal to 50 μm, greater than or equal to 100 μm, greater than or equal to 200 μm, greater than or equal to 300 μm, greater than or equal to 500 μm, greater than or equal to 1 mm, greater than or equal to 2 mm, greater than or equal to 3 mm, greater than or equal to 5 mm, in the range from 50 μm to 10 mm, in the range from 100 μm to 5 mm, in the range from 200 μm to 4 mm, in the range from 300 μm to 2 mm, or the like.

The values and ranges for the smaller of Z_{Rx,min} and Z_{Ry,min} (or for axisymmetric beams, the value of Z_{R}) specified herein are achievable for different wavelengths to which the workpiece is transparent through adjustment of the spot size parameter w_{o,min} defined in Equation (27). In different embodiments, the spot size parameter w_{o,min} is greater than or equal to 0.25 μm, greater than or equal to 0.50 μm, greater than or equal to 0.75 μm, greater than or equal to 1.0 μm, greater than or equal to 2.0 μm, greater than or equal to 3.0 μm, greater than or equal to 5.0 μm, in the range from 0.25 μm to 10 μm, in the range from 0.25 μm to 5.0 μm, in the range from 0.25 μm to 2.5 μm, in the range from 0.50 μm to 10 μm, in the range from 0.50 μm to 5.0 μm, in the range from 0.50 μm to 2.5 μm, in the range from 0.75 μm to 10 μm, in the range from 0.75 μm to 5.0 μm, in the range from 0.75 μm to 2.5 μm, or the like.

Non-diffracting or quasi non-diffracting beams generally have complicated intensity profiles, such as those that decrease non-monotonically vs. radius. By analogy to a Gaussian beam, an effective spot size w_{o,eff} can be defined for non-axisymmetric beams as the shortest radial distance, in any direction, from the radial position of the maximum intensity (r=0) at which the intensity decreases to 1/e² of the maximum intensity. Further, for axisymmetric beams W_{o,eff} is the radial distance from the radial position of the maximum intensity (r=0) at which the intensity decreases to 1/e² of the maximum intensity. A criterion for Rayleigh range based on the effective spot size w_{o,eff} for non-axisymmetric beams or the spot size wₒ for axisymmetric beams can be specified as non-diffracting or quasi non-diffracting beams for forming damage regions using equation (31) for non-axisymmetric beams of equation (32) for axisymmetric beams, below:

$$\begin{matrix}Smaller of {Z}_{Rx , min} , {Z}_{Ry , min} > {F}_{D} \frac{π {w}_{0 , eff}^{2}}{λ} & ( 31 ) \\ {Z}_{R} > {F}_{D} \frac{π {w}_{0}^{2}}{λ} & ( 32 )\end{matrix}$$

where F_{D} is a dimensionless divergence factor having a value of at least 10, at least 50, at least 100, at least 250, at least 500, at least 1000, in the range from 10 to 2000, in the range from 50 to 1500, in the range from 100 to 1000. By comparing Equation (31) to Equation (22) or (23), one can see that for a non-diffracting or quasi non-diffracting beam the distance, Smaller of Z_{Rx,min}, Z_{Ry,min} in Equation (31), over which the effective beam size doubles, is F_{D} times the distance expected if a typical Gaussian beam profile were used. The dimensionless divergence factor F_{D} provides a criterion for determining whether or not a laser beam is quasi-non-diffracting. As used herein, the pulsed laser beam 112 is considered quasi-non-diffracting if the characteristics of the laser beam satisfy Equation (31) or Equation (32) with a value of F_{D}≥10. As the value of F_{D} increases, the pulsed laser beam 112 approaches a more nearly perfect non-diffracting state. Moreover, it should be understood that Equation (32) is merely a simplification of Equation (31) and as such, Equation (31) mathematically describes the dimensionless divergence factor F_{D} for both axisymmetric and non-axisymmetric pulsed laser beams.

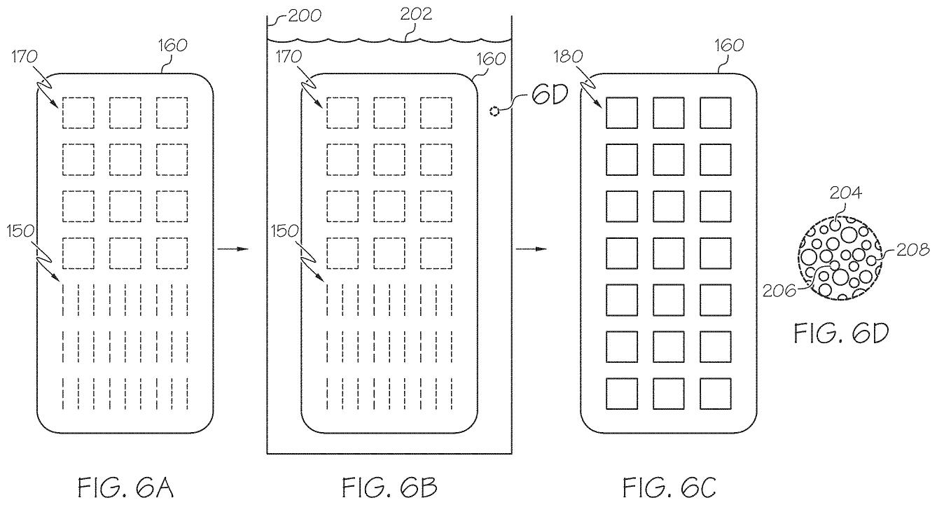

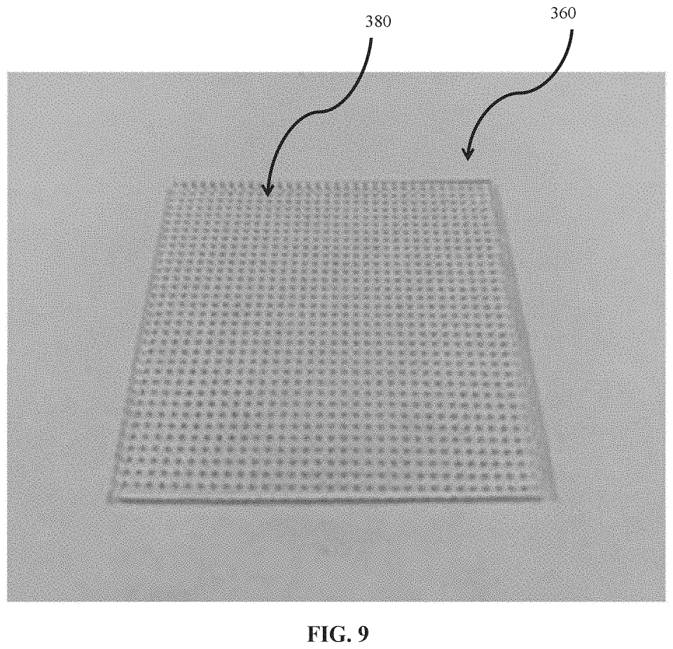

Referring now to FIGS. 1A and 1B by way of example, a transparent workpiece 160, such as a glass workpiece or a glass-ceramic workpiece, is schematically depicted undergoing processing according to the methods described herein. FIGS. 1A and 1B depict the formation of a closed contour 170 in the transparent workpiece 160, the closed contour 170 comprising a rectilinear shape, such as a square shape, a rectangular shape, a pentagonal shape, a hexagonal shape, or other polygonal shape. As shown in FIG. 1A, the closed contour 170 extends along a closed contour line 165 which delineates a line of intended separation along which one or more apertures 180 (FIGS. 6C and 9) may be formed in the transparent workpiece 160. The closed contour 170 comprises a plurality of defects 172 that extend into the surface of the transparent workpiece 160 and establish a path for separation of material of the transparent workpiece 160 enclosed by the closed contour 170 from the remaining transparent workpiece 160 thereby forming an aperture 180 (FIGS. 6C and 9) extending through the transparent workpiece 160, for example, by applying a chemical etching solution 202 (FIG. 6B) to the transparent workpiece 160, at least along the closed contour 170.

The closed contour 170 may be formed by translating at least one of a pulsed laser beam 112 and the transparent workpiece 160 relative to one another in a plurality of linear directions 101-104. For example, as shown in FIG. 1A, at least one of a pulsed laser beam 112 and the transparent workpiece 160 may be translated relative to one another in a first linear direction 101, a second linear direction 102, a third linear direction 103, and a fourth linear direction 104, for example, sequentially. The rectilinear shape of the closed contour 170 allows the closed contour 170 to be laser formed with linear passes of the pulsed laser beam 112 along a surface (e.g., the first surface 162) of the transparent workpiece 160, increasing the efficiency of closed contour 170 formation when compared to curvilinear (e.g., rounded) closed contours. Moreover, the closed contour 170 of defects 172 may be formed into an aperture 180 (FIGS. 6C and 9) via chemical etching much faster than a single defects 172 may be chemically etched into an aperture of the same maximum cross-sectional dimension.

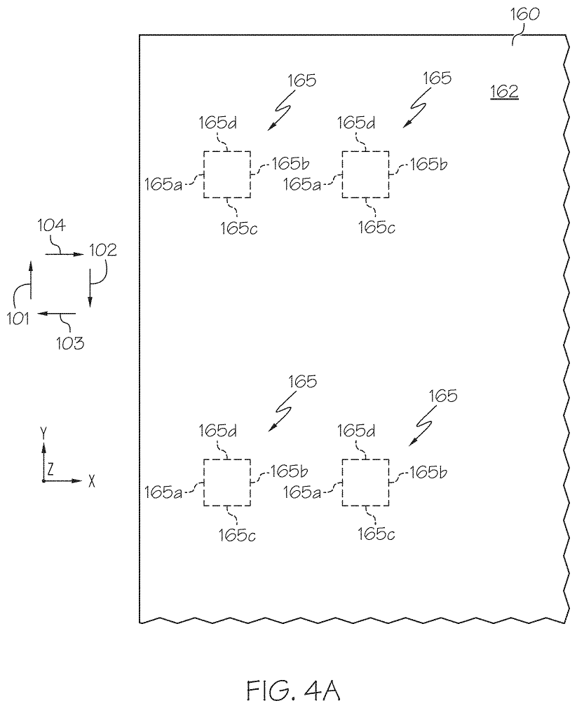

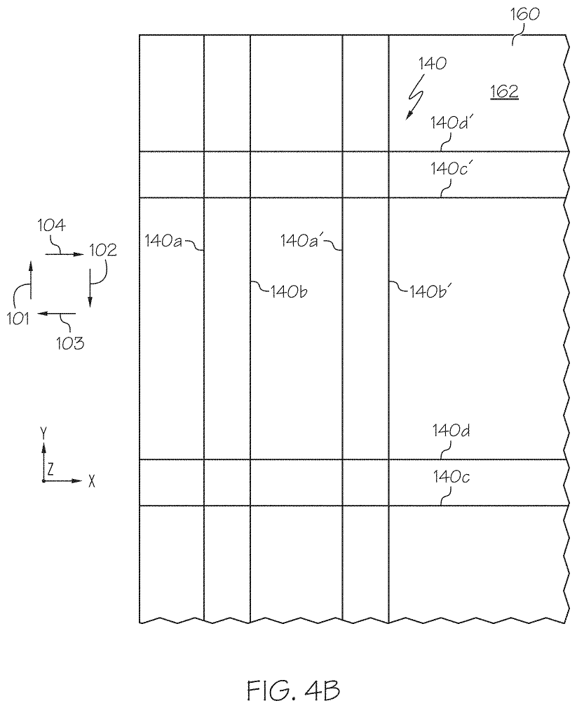

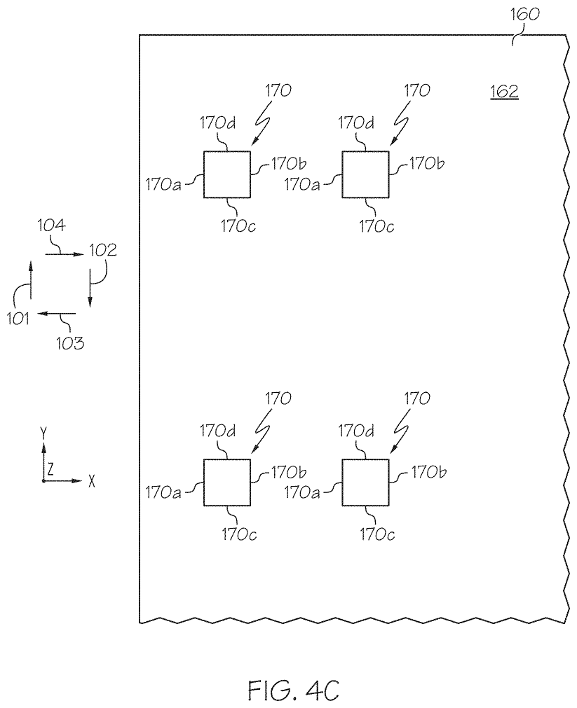

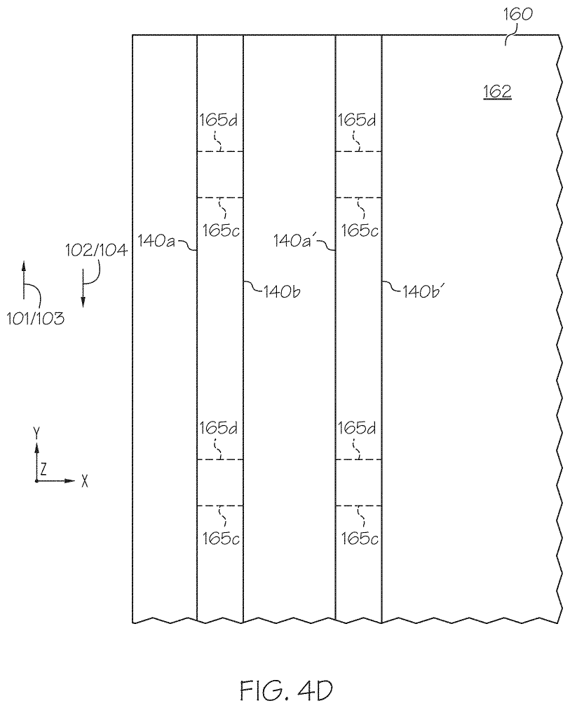

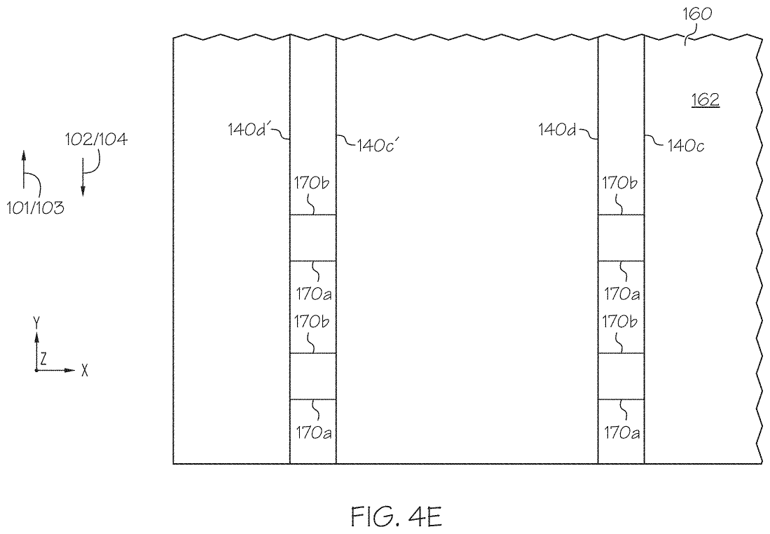

As shown in FIG. 1A (and shown in more detail in FIGS. 4A-4E) the closed contour line 165 comprises a first portion 165a (FIG. 4A), a second portion 165b, a third portion 165c and a fourth portion 165d. As also shown in FIG. 1A (and in more detail in FIGS. 4A-4E) laser processing the transparent workpiece 160 along the closed contour line 165 forms the closed contour 170 of defects 172 that includes a first portion of defects 170a, a second portion of defects 170b, a third portion of defects 170c (FIG. 4C) and a fourth portion of defects 170d (FIG. 4C). FIG. 1A schematically depicts the transparent workpiece 160 at a time during laser processing in which the pulsed laser beam 112 has already formed the first portion of defects 170a of the closed contour 170, is presently forming the second portion of defects 170b, and has yet to form the third portion of defects 170c (FIG. 4C) or the fourth portion of defects 170d (FIG. 4C).

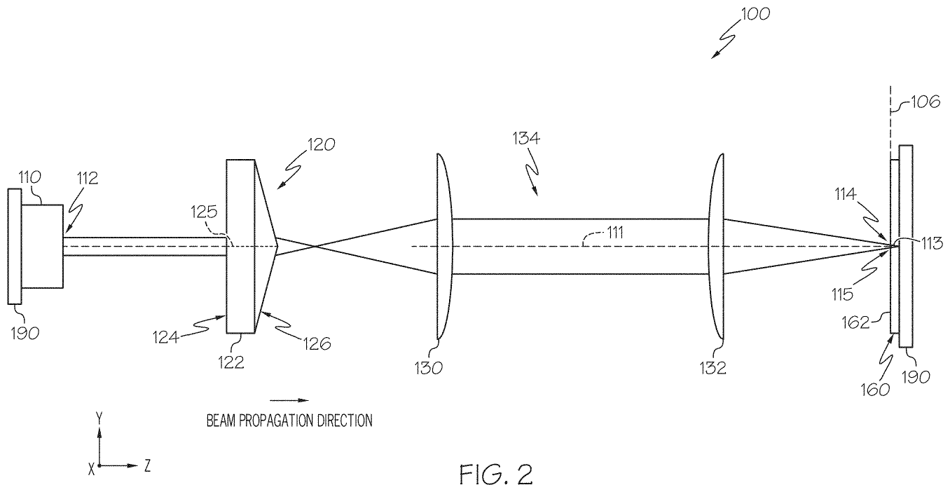

FIGS. 1A and 1B depict the pulsed laser beam 112 propagating along a beam pathway 111 and oriented such that the pulsed laser beam 112 may be focused into a pulsed laser beam focal line 113 within the transparent workpiece 160 using an aspheric optical element 120 (FIG. 2), for example, an axicon and one or more lenses (e.g., a first lens 130 and a second lens 132, as described below and depicted in FIG. 2). Further, the pulsed laser beam focal line 113 is a portion of a quasi-non-diffracting beam, as defined above. FIGS. 1A and 1B also depict that the pulsed laser beam 112 forms a beam spot 114 projected onto a first surface 162 of the transparent workpiece 160 at an impingement location 115, which is the location of contact between the pulsed laser beam 112 and the transparent workpiece 160. The transparent workpiece 160 also comprises a second surface 164 opposite the first surface 162. In some embodiments, the pulsed laser beam focal line 113 may comprise an axisymmetric cross section in a direction normal the beam pathway 111 (e.g., an axisymmetric beam spot) and in other embodiments, the pulsed laser beam focal line 113 may comprise a non-axisymmetric cross section in a direction normal the beam pathway 111 (e.g., a non-axisymmetric beam spot).

Further, as described in more detail below with respect to FIGS. 4A-4E embodiments described herein may be used to form a plurality of closed contours 170, for example, arrays of closed contours 170, in a single transparent workpiece 160 and thereby form a plurality of apertures 180, for example, arrays of apertures 180 (FIGS. 6C and 9). Adjacent apertures 180 of the plurality of the plurality of apertures 180 (e.g., of an array of apertures 180) may be spaced apart by an aperture spacing distance of from 0.1 mm to 5 mm, for example, from 0.1 mm to 3 mm, from 0.1 mm to 2 mm, from 0.5 mm to 5 mm, from 0.5 mm to 3 mm, from 0.5 mm to 2 mm, from 1 mm to 5 mm, from 1 mm to 3 mm, or from 1 mm to 2 mm. In an array of apertures 180, the aperture spacing distance may be fixed or variable. Transparent workpieces 160 having one or more apertures 180 may be used for a variety of purposes, for example, as part of an acoustic panel assembly. An acoustic panel assembly may comprise a first glass panel with a plurality of apertures (e.g., the transparent workpiece 160 having the plurality of apertures 180) coupled to a second glass panel. The second glass panel may be thicker than the first glass panel and does not include apertures. Acoustic panel assemblies may be used in an architectural application, for example, disposed within the walls of a building to provide sound absorbing functionality. The apertures 180 comprise the rectilinear shape of the closed contours 170 and it should be understood that the rectilinear apertures impart no acoustic performance penalty as compared to curvilinear apertures.

Referring again to FIGS. 1A and 1B, in the embodiments described herein, a pulsed laser beam 112 (with the beam spot 114 projected onto the transparent workpiece 160) may be directed onto the transparent workpiece 160 (e.g., condensed into a high aspect ratio line focus that penetrates through at least a portion of the thickness of the transparent workpiece 160). This forms the pulsed laser beam focal line 113. Further, the beam spot 114 is an example cross section of the pulsed laser beam focal line 113 and when the pulsed laser beam focal line 113 irradiates the transparent workpiece 160 (forming the beam spot 114), the pulsed laser beam focal line 113 penetrates at least a portion of the transparent workpiece 160.

During laser processing, at least one of the pulsed laser beam 112 and the transparent workpiece 160 may be translated relative to one another in a linear direction (e.g., one of the linear directions 101-104) to form defects 172 of the closed contour 170. Directing or localizing the pulsed laser beam 112 into the transparent workpiece 160 generates an induced absorption within the transparent workpiece 160 and deposits enough energy to break chemical bonds in the transparent workpiece 160 at spaced locations along the closed contour line 165 to form the defects 172. According to one or more embodiments, the pulsed laser beam 112 may be translated across the transparent workpiece 160 by motion of the transparent workpiece 160 (e.g., motion of a translation stage 190 coupled to the transparent workpiece 160), motion of the pulsed laser beam 112 (e.g., motion of the pulsed laser beam focal line 113), or motion of both the transparent workpiece 160 and the pulsed laser beam focal line 113. By translating the pulsed laser beam focal line 113 relative to the transparent workpiece 160, the plurality of defects 172 may be formed in the transparent workpiece 160.

Referring now to FIG. 2, an optical assembly 100 for producing a pulsed laser beam 112 that that is quasi-non-diffracting and forms the pulsed laser beam focal line 113 at the transparent workpiece 160 using the aspheric optical element 120 (e.g., an axicon 122) is schematically depicted. The optical assembly 100 includes a beam source 110 that outputs the pulsed laser beam 112, and a first and second lens 130, 132. Further, the transparent workpiece 160 may be positioned such that the pulsed laser beam 112 output by the beam source 110 irradiates the transparent workpiece 160, for example, after traversing the aspheric optical element 120 and thereafter, both the first lens 130 and the second lens 132. A beam pathway 111 extends between the beam source 110 and the transparent workpiece 160 along the Z-axis such that when the beam source 110 outputs the pulsed laser beam 112, the pulsed laser beam 112 extends along the beam pathway 111.

Referring still to FIG. 2, the beam source 110 may comprise any known or yet to be developed beam source 110 configured to output pulsed laser beams 112. In other words, the beam source 110 is a pulsed beam source. In operation, the defects 172 of the closed contour 170 (FIGS. 1A and 4C) are produced by interaction of the transparent workpiece 160 with the pulsed laser beam 112 output by the beam source 110. In some embodiments, the beam source 110 may output a pulsed laser beam 112 comprising a wavelength of, for example, 1064 nm, 1030 nm, 532 nm, 530 nm, 355 nm, 343 nm, or 266 nm, or 215 nm. Further, the pulsed laser beam 112 used to form defects 172 in the transparent workpiece 160 may be well suited for materials that are transparent to the selected pulsed laser wavelength.

Suitable laser wavelengths for forming defects 172 are wavelengths at which the combined losses of linear absorption and scattering by the transparent workpiece 160 are sufficiently low. In embodiments, the combined losses due to linear absorption and scattering by the transparent workpiece 160 at the wavelength are less than 20%/mm, or less than 15%/mm, or less than 10%/mm, or less than 5%/mm, or less than 1%/mm, where the dimension “/mm” means per millimeter of distance within the transparent workpiece 160 in the beam propagation direction of the pulsed laser beam 112 (e.g., the z-direction). Representative wavelengths for many glass workpieces include fundamental and harmonic wavelengths of Nd³⁺ (e.g. Nd³⁺:YAG or Nd³⁺:YVO₄ having fundamental wavelength near 1064 nm and higher order harmonic wavelengths near 532 nm, 355 nm, and 266 nm). Other wavelengths in the ultraviolet, visible, and infrared portions of the spectrum that satisfy the combined linear absorption and scattering loss requirement for a given substrate material can also be used.

In operation, the pulsed laser beam 112 output by the beam source 110 may create multi-photon absorption (MPA) in the transparent workpiece 160. MPA is the simultaneous absorption of two or more photons of identical or different frequencies that excites a molecule from one state (usually the ground state) to a higher energy electronic state (i.e., ionization). The energy difference between the involved lower and upper states of the molecule is equal to the sum of the energies of the involved photons. MPA, also called induced absorption, can be a second-order or third-order process (or higher order), for example, that is several orders of magnitude weaker than linear absorption. It differs from linear absorption in that the strength of second-order induced absorption may be proportional to the square of the light intensity, for example, and thus it is a nonlinear optical process.

The perforation step that creates the closed contour 170 (FIGS. 1A and 4C) may utilize the beam source 110 (e.g., an ultra-short pulse laser) in combination with the aspheric optical element 120, the first lens 130, and the second lens 132, to project the beam spot 114 on the transparent workpiece 160 and generate the pulsed laser beam focal line 113. The pulsed laser beam focal line 113 comprises a quasi-non-diffracting beam, such as a Gauss-Bessel beam or Bessel beam, as defined above, and may fully perforate the transparent workpiece 160 to form defects 172 in the transparent workpiece 160, which may form the closed contour 170. In some embodiments, the pulse duration of the individual pulses is in a range of from 1 femtosecond to 200 picoseconds, such as from 1 picosecond to 100 picoseconds, 5 picoseconds to 20 picoseconds, or the like, and the repetition rate of the individual pulses may be in a range from 1 kHz to 4 MHz, such as in a range from 10 kHz to 3 MHz, or from 10 kHz to 650 kHz.

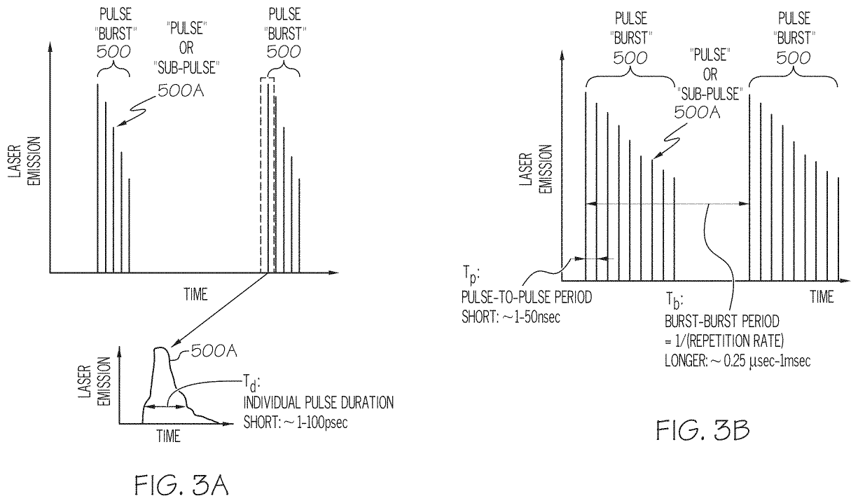

Referring also to FIGS. 3A and 3B, in addition to a single pulse operation at the aforementioned individual pulse repetition rates, the pulses may be produced in pulse bursts 500 of two sub-pulses 500A or more (such as, for example, 3 sub-pulses, 4 sub-pulses, 5 sub-pulses, 10 sub-pulses, 15 sub-pulses, 20 sub-pulses, or more per pulse burst, such as from 2 to 30 sub-pulses per pulse burst 500, or from 5 to 20 sub-pulses per pulse burst 500). While not intending to be limited by theory, a pulse burst is a short and fast grouping of sub-pulses that creates an optical energy interaction with the material (i.e. MPA in the material of the transparent workpiece 160) on a time scale not easily accessible using a single-pulse operation. While still not intending to be limited by theory, the energy within a pulse burst (i.e. the pulse burst energy) is conserved. As an illustrative example, for a pulse burst having an energy of 100 μJ per pulse burst and 2 sub-pulses, the 100 μJ per pulse burst energy is split between the 2 sub-pulses for an average energy of 50 μJ per sub-pulse. As another illustrative example, for a pulse burst having an energy of 100 μJ per pulse burst and 10 sub-pulses, the 100 μJ per pulse burst is split amongst the 10 sub-pulses for an average energy of 10 μJ per sub-pulse. Further, the energy distribution among the sub-pulses of a pulse burst does not need to be uniform. In fact, in some instances, the energy distribution among the sub-pulses of a pulse burst is in the form of an exponential decay, where the first sub-pulse of the pulse burst contains the most energy, the second sub-pulse of the pulse burst contains slightly less energy, the third sub-pulse of the pulse burst contains even less energy, and so on. However, other energy distributions within an individual pulse burst are also possible, where the exact energy of each sub-pulse can be tailored to effect different amounts of modification to the transparent workpiece 160.

While still not intending to be limited by theory, when the defects 172 of the closed contour 170 are formed with pulse bursts having at least two sub-pulses, the force necessary to separate the transparent workpiece 160 along is closed contour 170 (i.e. the maximum break resistance) is reduced compared to the maximum break resistance of a closed contour 170 of the same shape with the same spacing between adjacent defects 172 in an identical transparent workpiece 160 that is formed using a single pulse laser. For example, the maximum break resistance of a closed contour 170 formed using a single pulse is at least two times greater than the maximum break resistance of a closed contour 170 formed using a pulse burst having 2 or more sub-pulses. Further, the difference in maximum break resistance between a closed contour 170 formed using a single pulse and a closed contour 170 formed using a pulse burst having 2 sub-pulses is greater than the difference in maximum break resistance between a closed contour 170 formed using a pulse burst having 2 sub-pulses and a pulse burst having 3 sub-pulses. Thus, pulse bursts may be used to form closed contours 170 that separate easier than closed contours 170 formed using a single pulse laser.

Referring still to FIGS. 3A and 3B, the sub-pulses 500A within the pulse burst 500 may be separated by a duration that is in a range from 1 nsec to 50 nsec, for example, from 10 nsec to 30 nsec, such as 20 nsec. In other embodiments, the sub-pulses 500A within the pulse burst 500 may be separated by a duration of up to 100 psec (for example, 0.1 psec, 5 psec, 10 psec, 15 psec, 18 psec, 20 psec, 22 psec, 25 psec, 30 psec, 50 psec, 75 psec, or any range therebetween). For a given laser, the time separation Tₚ (FIG. 4B) between adjacent sub-pulses 500A within a pulse burst 500 may be relatively uniform (e.g., within 10% of one another). For example, in some embodiments, each sub-pulse 500A within a pulse burst 500 is separated in time from the subsequent sub-pulse by approximately 20 nsec (50 MHz). Further, the time between each pulse burst 500 may be from 0.25 microseconds to 1000 microseconds, e.g., from 1 microsecond to 10 microseconds, or from 3 microseconds to 8 microseconds.

In some of the exemplary embodiments of the beam source 110 described herein, the time separation T_{b} (FIG. 3B) is 5 microseconds for the beam source 110 outputting a pulsed laser beam 112 comprising a burst repetition rate of 200 kHz. The laser burst repetition rate is related to the time T_{b} between the first pulse in a burst to the first pulse in the subsequent burst (laser burst repetition rate=1/T_{b}). In some embodiments, the laser burst repetition rate may be in a range of from 1 kHz to 4 MHz. In embodiments, the laser burst repetition rates may be, for example, in a range of from 10 kHz to 650 kHz. The time T_{b} between the first pulse in each burst to the first pulse in the subsequent burst may be from 0.25 microsecond (4 MHz burst repetition rate) to 1000 microseconds (1 kHz burst repetition rate), for example from 0.5 microseconds (2 MHz burst repetition rate) to 40 microseconds (25 kHz burst repetition rate), or from 2 microseconds (500 kHz burst repetition rate) to 20 microseconds (50 k Hz burst repetition rate). The exact timing, pulse duration, and burst repetition rate may vary depending on the laser design, but short pulses (T_{d}<20 psec and, in some embodiments, T_{d}≤15 psec) of high intensity have been shown to work particularly well.

The burst repetition rate may be in a range of from 1 kHz to 2 MHz, such as from 1 kHz to 200 kHz. Bursting or producing pulse bursts 500 is a type of laser operation where the emission of sub-pulses 500A is not in a uniform and steady stream but rather in tight clusters of pulse bursts 500. The pulse burst laser beam may have a wavelength selected based on the material of the transparent workpiece 160 being operated on such that the material of the transparent workpiece 160 is substantially transparent at the wavelength. The average laser power per burst measured at the material may be at least 40 μJ per mm of thickness of material. For example, in embodiments, the average laser power per burst may be from 40 μJ/mm to 2500 μJ/mm, or from 500 μJ/mm to 2250 μJ/mm. In a specific example, for 0.5 mm to 0.7 mm thick Corning EAGLE XG® transparent workpiece, pulse bursts of from 300 μJ to 600 μJ may cut and/or separate the workpiece, which corresponds to an exemplary range of 428 μJ/mm to 1200 μJ/mm (i.e., 300 μJ/0.7 mm for 0.7 mm EAGLE XGA glass and 600 μJ/0.5 mm for a 0.5 mm EAGLE XG® glass).

The energy required to modify the transparent workpiece 160 is the pulse energy, which may be described in terms of pules burst energy (i.e., the energy contained within a pulse burst 500 where each pulse burst 500 contains a series of sub-pulses 500A), or in terms of the energy contained within a single laser pulse. The pulse energy (for example, the pulse burst energy or the energy of a single laser pulse) may be from 25 μJ to 750 μJ, e.g., from 50 μJ to 500 μJ, or from 50 μJ to 250 μJ. For some glass compositions, the pulse energy may be from 100 μJ to 250 μJ. However, for display or TFT glass compositions, the pulse energy may be higher (e.g., from 300 μJ to 500 μJ, or from 400 μJ to 600 μJ, depending on the specific glass composition of the transparent workpiece 160).

While not intending to be limited by theory, the use of a pulsed laser beam 112 capable of generating pulse bursts is advantageous for cutting or modifying transparent materials, for example glass. In contrast with the use of single pulses spaced apart in time by the repetition rate of the single-pulsed laser, the use of a burst sequence that spreads the pulse energy over a rapid sequence of pulses within the burst allows access to larger timescales of high intensity interaction with the material than is possible with single-pulse lasers. Further, using pulse bursts is advantageous for forming closed contours 170 comprising the defects 172 that are separated from the transparent workpiece 160 using chemical etching, as described herein. In particular, pulse bursts facilitate formation of adjacent defects 172 that have connected or nearly connected cracks, allowing a chemical etching solution 202 (FIGS. 6A-6C) to rapidly penetrate through the depth of the defects 172, minimizing the amount of material of the transparent workpiece 160 removed and the amount of byproducts formed when separating the closed contour 170 and forming apertures 180, as described in more detail below. The use of pulse bursts (as opposed to a single pulse operation) increases the size (e.g., the cross-sectional size) of the defects 172, which facilitates the connection of adjacent defects 172 when separating the closed contour 170 to form the apertures 180, thereby minimizing crack formation from the aperture 180 into the interior of the transparent workpiece 180. Further, using a pulse burst to form defects 172 increases the randomness of the orientation of cracks extending outward from each defect 172 into the such that individual cracks extending outward from defects 172 do not influence or otherwise bias the separation of the closed contour 170 to form the corresponding aperture 180 such that separation of the defects 172 follows the closed contour 170.

Referring again to FIG. 2, the aspheric optical element 120 is positioned within the beam pathway 111 between the beam source 110 and the transparent workpiece 160. In operation, propagating the pulsed laser beam 112, e.g., an incoming Gaussian beam, through the aspheric optical element 120 may alter the pulsed laser beam 112 such that the portion of the pulsed laser beam 112 propagating beyond the aspheric optical element 120 is quasi-non-diffracting, as described above. The aspheric optical element 120 may comprise any optical element comprising an aspherical shape. In some embodiments, the aspheric optical element 120 may comprise a conical wavefront producing optical element, such as an axicon lens, for example, a negative refractive axicon lens, a positive refractive axicon lens, a reflective axicon lens, a diffractive axicon lens, a programmable spatial light modulator axicon lens (e.g., a phase axicon), or the like.

In some embodiments, the aspheric optical element 120 comprises at least one aspheric surface whose shape is mathematically described as: z′=(cr²/1)+(1 (1+k)(c²r²))^{1/2}+(a₁r+a₂r²+a₃r³+a₄r⁴+a₅r⁵+a₆r⁶+a₇r⁷+a₈r⁸+a₉r⁹+a₁₀r¹⁰+a₁₁r¹¹+a₁₂r¹² where z′ is the surface sag of the aspheric surface, r is the distance between the aspheric surface and the an axis of the beam pathway 111 in a radial direction (e.g., in an X-direction or a Y-direction), c is the surface curvature of the aspheric surface (i.e. cᵢ=1/Rᵢ, where R is the surface radius of the aspheric surface), k is the conic constant, and coefficients aᵢ are the first through the twelfth order aspheric coefficients or higher order aspheric coefficients (polynomial aspheres) describing the aspheric surface. In one example embodiment, at least one aspheric surface of the aspheric optical element 120 includes the following coefficients a₁-a₇, respectively: −0.085274788; 0.065748845; 0.077574995; −0.054148636; 0.022077021; −0.0054987472; 0.0006682955; and the aspheric coefficients a₈-a₁₂ are 0. In this embodiment, the at least one aspheric surface has the conic constant k=0. However, because the a₁ coefficient has a nonzero value, this is equivalent to having a conic constant k with a non-zero value. Accordingly, an equivalent surface may be described by specifying a conic constant k that is non zero, a coefficient a₁ that is non-zero, or a combination of a nonzero k and a non-zero coefficient a₁. Further, in some embodiments, the at least one aspheric surface is described or defined by at least one higher order aspheric coefficients a₂-a₁₂ with non-zero value (i.e., at least one of a₂, a₃ . . . , a₁₂≠0). In one example embodiment, the aspheric optical element 120 comprises a third-order aspheric optical element such as a cubically shaped optical element, which comprises a coefficient a₃ that is non-zero.

In some embodiments, when the aspheric optical element 120 comprises an axicon 122 (as depicted in FIG. 2), the axicon 122 may have a laser output surface 126 (e.g., conical surface) having an angle of 1.2°, such as from 0.5° to 5°, or from 1° to 1.5°, or even from 0.5° to 20°, the angle measured relative to the laser input surface 124 (e.g., flat surface) upon which the pulsed laser beam 112 enters the axicon 122. Further, the laser output surface 126 terminates at a conical tip. Moreover, the aspheric optical element 120 includes a centerline axis 125 extending from the laser input surface 124 to the laser output surface 126 and terminating at the conical tip. In other embodiments, the aspheric optical element 120 may comprise a spatial phase modulator, such as a spatial light modulator, or a diffractive optical grating. In operation, the aspheric optical element 120 shapes the incoming pulsed laser beam 112 (e.g., an incoming Gaussian beam) into a quasi-non-diffracting beam, which, in turn, is directed through the first lens 130 and the second lens 132.

Referring still to FIG. 2, the first lens 130 is positioned upstream the second lens 132 and may collimate the pulsed laser beam 112 within a collimation space 134 between the first lens 130 and the second lens 132. Further, the second lens 132 may focus the pulsed laser beam 112 into the transparent workpiece 160, which may be positioned at an imaging plane 106. In some embodiments, the first lens 130 and the second lens 132 each comprise plano-convex lenses. When the first lens 130 and the second lens 132 each comprise plano-convex lenses, the curvature of the first lens 130 and the second lens 132 may each be oriented toward the collimation space 134. In other embodiments, the first lens 130 may comprise other collimating lenses and the second lens 132 may comprise a meniscus lens, an asphere, or another higher-order corrected focusing lens.

Referring now to FIGS. 1A-4C, a method of laser forming a closed contour 170 of defects 172 comprising a rectilinear shape will now be described in detail. The method includes directing (e.g., localizing) the pulsed laser beam 112 oriented along the beam pathway 111 and output by the beam source 110 into the transparent workpiece 160 such that the portion of the pulsed laser beam 112 directed into the transparent workpiece 160 generates an induced absorption within the transparent workpiece and the induced absorption produces a defect 172 within the transparent workpiece 160. For example, the pulsed laser beam 112 may comprise a pulse energy and a pulse duration sufficient to exceed a damage threshold of the transparent workpiece 160. In some embodiments, directing the pulsed laser beam 112 into the transparent workpiece 160 comprises focusing the pulsed laser beam 112 output by the beam source 110 into the pulsed laser beam focal line 113 oriented along the beam propagation direction (e.g., the z-axis). The transparent workpiece 160 is positioned in the beam pathway 111 to at least partially overlap the pulsed laser beam focal line 113 of pulsed laser beam 112. The pulsed laser beam focal line 113 is thus directed into the transparent workpiece 160. The pulsed laser beam 112, e.g., the pulsed laser beam focal line 113 generates induced absorption within the transparent workpiece 160 to create the defect 172 in the transparent workpiece 160. In some embodiments, individual defects 172 may be created at rates of several hundred kilohertz (i.e., several hundred thousand defects per second).

In some embodiments, the aspheric optical element 120 may focus the pulsed laser beam 112 into the pulsed laser beam focal line 113. In operation, the position of the pulsed laser beam focal line 113 may be controlled by suitably positioning and/or aligning the pulsed laser beam 112 relative to the transparent workpiece 160 as well as by suitably selecting the parameters of the optical assembly 100. For example, the position of the pulsed laser beam focal line 113 may be controlled along the z-axis and about the z-axis. Further, the pulsed laser beam focal line 113 may have a length in a range of from 0.1 mm to 100 mm or in a range of from 0.1 mm to 10 mm. Various embodiments may be configured to have a pulsed laser beam focal line 113 with a length 1 of 0.1 mm, 0.2 mm, 0.3 mm, 0.4 mm, 0.5 mm, 0.7 mm, 1 mm, 2 mm, 3 mm, 4 mm, or 5 mm e.g., from 0.5 mm to 5 mm.

Referring now to FIGS. 4A-4C, the formation of multiple rectilinear closed contours 170 are depicted. FIG. 4A depicts a plurality of closed contour lines 165, each comprising four portions: the first portion 165a, the second portion 165b, the third portion 165c, and the fourth portion 165d. Each portion of the closed contour lines 165 is linear as the closed contour lines 165 comprise a rectilinear shape. Further, FIG. 4B depicts a plurality of linear paths 140 along which at least one of the transparent workpiece 160 and the pulsed laser beam focal line 113 may be translated, where each linear path 140 coincides with a portion of a closed contour line 165. FIG. 4C depicts a plurality of closed contours 170 each comprising a rectilinear shape. Each of the closed contours 170 of FIG. 4C comprise a first portion of defects 170a corresponding with the first portion 165a of the closed contour line 165, a second portion of defects 170b corresponding with the second portion 165b of the closed contour line 165, a third portion of defects 170c corresponding with the third portion 165c of the closed contour line 165, and a fourth portion of defects 170d corresponding with the fourth portion 165d of the closed contour line 165.

Referring still to FIG. 4A-4C, the process of laser forming rectilinear closed contours 170 includes translating at least one of the transparent workpiece 160 and the pulsed laser beam focal line 113 in the first linear direction 101 along a first linear path 140a. As shown in FIG. 2B, the first linear path 140a coincides with the first portion 165a of the closed contour line 165 such that the pulsed laser beam focal line 113 may irradiate the transparent workpiece 160 along the first portion 165a of the closed contour line 165, thereby laser forming the first portion of defects 170a of at least one closed contour 170. Further, as shown in FIGS. 4A-4C, a single pass of the pulsed laser beam focal line 113 along the first linear path 140a may form multiple first portions of defects 170a of multiple closed contours 170. For example, the first linear path 140a shown in FIG. 4B coincides with the first portions 165a of two closed contour lines 165 and it should be understood that the first linear path 140a may coincide with portions (e.g., first portions 165a) of any number of closed contour lines 165 such that a single pass of the pulsed laser beam focal line 113 along the first linear path 140a may laser form portions of defects 172 (e.g., first portions of defects 170a) of any number of closed contours 170.

Referring still to FIG. 4A-4C, the process of laser forming rectilinear closed contours 170 includes translating at least one of the transparent workpiece 160 and the pulsed laser beam focal line 113 in the second linear direction 102 along a second linear path 140b. The second linear direction 102 is opposite the first linear direction 101. As shown in FIG. 4B, the second linear path 140b coincides with the second portion 165b of the closed contour line 165 such that the pulsed laser beam focal line 113 may irradiate the transparent workpiece 160 along the second portion 165b of the closed contour line 165, thereby laser forming the second portion of defects 170b of at least one closed contour 170. Further, as shown in FIGS. 4A-4C, a single pass of the pulsed laser beam focal line 113 along the second linear path 140b may form multiple second portions of defects 170b of multiple closed contours 170. For example, the second linear path 140b shown in FIG. 4B coincides with the second portions 165b of two closed contour lines 165 and it should be understood that the second linear path 140b may coincide with portions (e.g., second portions 165b) of any number of closed contour lines 165 such that a single pass of the pulsed laser beam focal line 113 along the second linear path 140b may laser form portions of defects (e.g., second portions of defects 170b) of any number of closed contours 170.

In embodiments comprising arrays of closed contour lines 165 disposed in multiple rows, which may be laser formed into arrays of closed contours 170 disposed in multiple rows, as depicted in FIGS. 4A-4C, the pulsed laser beam focal line 113 may be translated in alternating passes in the first linear direction 101 and the second linear direction 102 along linear paths coinciding with portions of closed contour lines 165 of multiple rows of adjacent closed contour lines 165. As an illustrative example, FIG. 4B shows the first linear path 140a spaced apart from the second linear path 140b in an x-direction and also shows a first linear path 140a′ and a second linear path 140b′ that coincide with portions of two closed contour lines 165 spaced apart from the two closed contour lines 165 that coincide with the first and second linear paths 140a, 140b. In some embodiments, the pulsed laser beam focal line 113 may be translated in a plurality of alternating passes in the first linear direction 101 and the second linear direction 102 to laser form the first portion of defects 170a and the second portion of defects 170b of each of the closed contours 170 of an array of closed contours 170.

Referring still to FIGS. 4A-4C, the process of laser forming rectilinear closed contours 170 also includes translating at least one of the transparent workpiece 160 and the pulsed laser beam focal line 113 in the third linear direction 103 along the third linear path 140c. As shown in FIG. 2B, the third linear path 140c coincides with the third portion 165c of the closed contour line 165 such that the pulsed laser beam focal line 113 may irradiate the transparent workpiece 160 along the third portion 165c of the closed contour line 165, thereby laser forming the third portion of defects 170c of at least one closed contour 170. Further, as shown in FIGS. 4A-4C, a single pass of the pulsed laser beam focal line 113 along the third linear path 140c may form multiple third portions of defects 170c of multiple closed contours 170. For example, the third linear path 140c shown in FIG. 4B coincides with the third portions 165c of two closed contour lines 165 and it should be understood that the third linear path 140c may coincide with portions (e.g., third portions 165c) of any number of closed contour lines 165 such that a single pass of the pulsed laser beam focal line 113 along the third linear path 140c may laser form portions of defects (e.g., third portions of defects 170c) of any number of closed contours 170.

Next, the process of laser forming rectilinear closed contours 170 includes translating at least one of the transparent workpiece 160 and the pulsed laser beam focal line 113 in the fourth linear direction 104 along the fourth linear path 140d. The fourth linear direction 104 is opposite the third linear direction 103. As shown in FIG. 4B, the fourth linear path 140d coincides with the fourth portion 165d of the closed contour line 165 such that the pulsed laser beam focal line 113 may irradiate the transparent workpiece 160 along the fourth portion 165d of the closed contour line 165, thereby laser forming the fourth portion of defects 170d of at least one closed contour 170. Further, as shown in FIGS. 4A-4C, a single pass of the pulsed laser beam focal line 113 along the fourth linear path 140d may form multiple fourth portions of defects 170d of multiple closed contours 170. For example, the fourth linear path 140d shown in FIG. 4B coincides with the fourth portions 165d of two closed contour lines 165 and it should be understood that the fourth linear path 140d may coincide with portions (e.g., fourth portions 165d) of any number of closed contour lines 165 such that a single pass of the pulsed laser beam focal line 113 along the fourth linear path 140d may laser form portions of defects (e.g., fourth portions of defects 170d) of any number of closed contours 170.

In embodiments comprising arrays of closed contour lines 165 disposed in multiple rows, which may be laser formed into arrays of closed contours 170 disposed in multiple rows, as depicted in FIGS. 4A-4C, the pulsed laser beam focal line 113 may be translated in alternating passes in the third linear direction 103 and the fourth linear direction 104 along linear paths coinciding with portions of closed contour lines 165 of multiple rows of adjacent closed contour lines 165, for example, after alternating passes in the first linear direction 101 and the second linear direction 102. As an illustrative example, FIG. 4B shows the third linear path 140c spaced apart from the fourth linear path 140d in a y-direction and also shows a third linear path 140c′ and a fourth linear path 140d′ that coincide with portions of two closed contour lines 165 spaced apart from the two closed contour lines 165 that coincide with the third and fourth linear paths 140c, 140d. In some embodiments, the pulsed laser beam focal line 113 may be translated in a plurality of alternating passes in the third linear direction 103 and the fourth linear direction 104 to laser form the third portion of defects 170c and the fourth portion of defects 170d of each of the closed contours 170 of an array of closed contours 170.

Referring still to FIGS. 4A-4C, in some embodiments, the first linear direction 101 and the third linear direction 103 are different directions and the second linear direction 102 and the fourth linear direction 104 are different directions. For example, the first linear path 140a and the second linear path 140b may each be orthogonal the third linear path 140c and the fourth linear path 140d. However, in other embodiments, as depicted in FIGS. 4D and 4E, the third linear direction 103 is the same as the first linear direction 101 and the fourth linear direction 104 is the same as the second linear direction 102. In this embodiment, the first portion of defects 170a and the second portion of defects 170b of a plurality of closed contours 170 may be formed by translating the pulsed laser beam focal line 113 in alternating passes in the first linear direction 101 and the second linear direction 102 along linear paths coinciding with the first portion 165a and the second portion 165b of a plurality of closed contour lines 165, as shown in FIG. 4D, then rotating the transparent workpiece 160 by 90°, and translating the pulsed laser beam focal line 113 in alternating passes in the first linear direction 101 and the second linear direction 102, again, this time along linear paths coinciding with the third portion 165c and the fourth portion 165d of a plurality of closed contour lines 165, as shown in FIG. 4E.

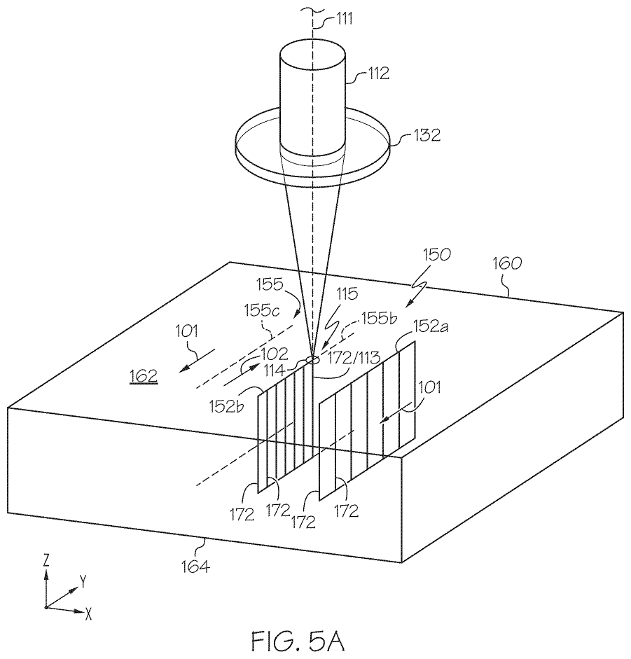

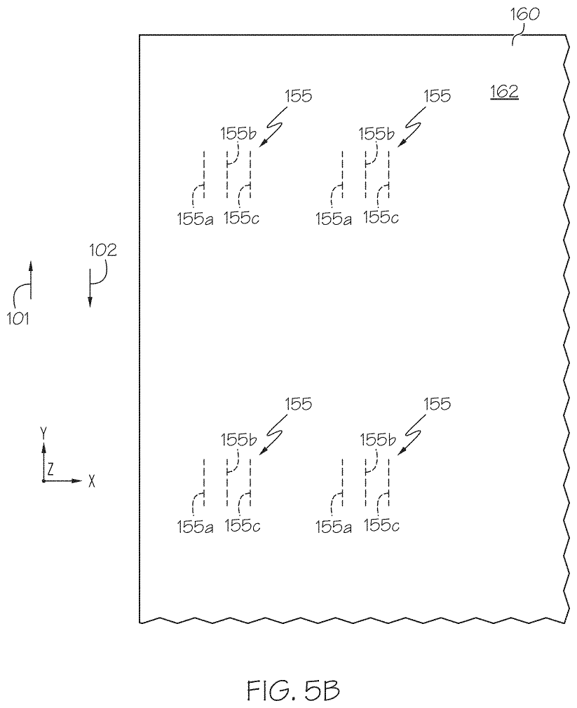

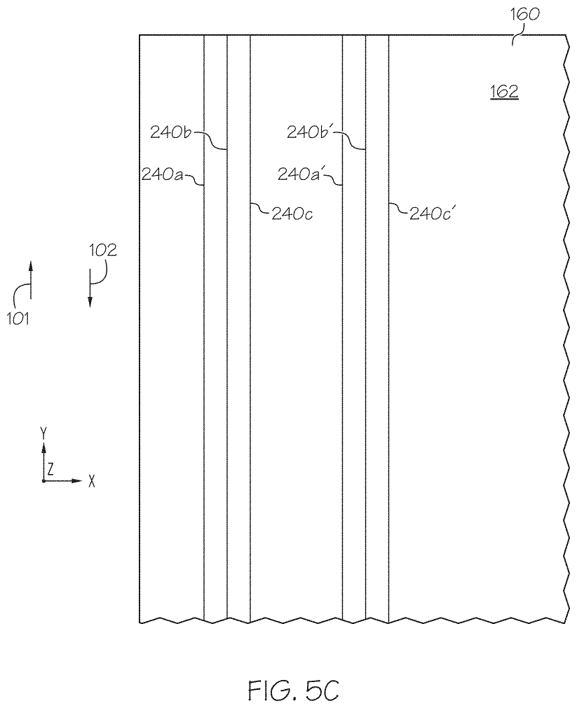

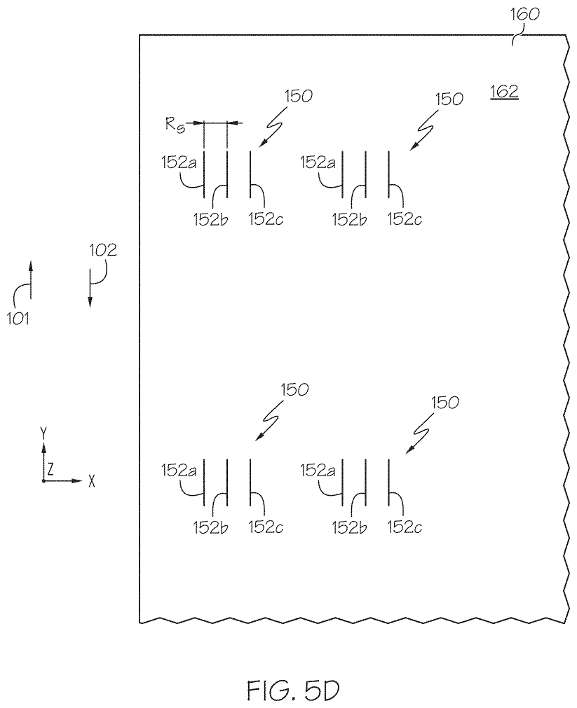

Referring now to FIGS. 5A-5D, the laser formation of a linear array of defects 150 in the transparent workpiece 160 is depicted. As shown in FIG. 5A-5D, the linear array of defects 150 comprises three or more defect rows 152 each formed along one of a plurality of linear array lines 155. Like the closed contour lines 165 described above, the linear array lines 155 represent a path of desired separation along a surface of the transparent workpiece 160 (e.g., the first surface 162). As also shown in FIG. 5A (and in more detail in FIGS. 5B-5D) laser processing the transparent workpiece 160 along the linear array lines 155 forms the linear array of defects 150 that includes a first defect row 152a, a second defect row 152b, and a third defect row 152c. FIG. 5A schematically depicts the transparent workpiece 160 at a time during laser processing in which the pulsed laser beam 112 has already formed the first defect row 152a of the linear array of defects 150, is presently forming the second defect row 152b, and has yet to form the third defect row 152c. Further, adjacent defect rows 152 of the linear array of defects 150 may be spaced apart by a row spacing distance R_{S}, as shown in FIG. 5D. The row spacing distance R_{S} may be 100 μm or less, for example 100 μm or less, 90 μm or less, 80 μm or less, 75 μm or less, 70 μm or less, 60 μm or less, 50 μm or less, 40 μm or less, 30 μm or less, 20 μm or less or the like.

Referring now to FIGS. 5B-5D, the process of laser forming linear arrays of defects 150 includes translating at least one of the transparent workpiece 160 and the pulsed laser beam focal line 113 in the first linear direction 101 along a first linear path 240a. As shown in FIG. 5C, the first linear path 240a coincides with a first linear array line 155a such that the pulsed laser beam focal line 113 may irradiate the transparent workpiece 160 along the first linear array line 155a, thereby laser forming the first defect row 152a of at least one linear array of defects 150. Further, as shown in FIGS. 5B-5D, a single pass of the pulsed laser beam focal line 113 along the first linear path 240a may form multiple first defect rows 152a of multiple linear arrays of defects 150. For example, the first linear path 240a shown in FIG. 5C coincides with two first linear array lines 155a and it should be understood that the first linear path 240a may coincide with any number of first linear array lines 155a such that a single pass of the pulsed laser beam focal line 113 along the first linear path 240a may laser form portions of defects 172 (e.g., first defect rows 152a) of any number of linear arrays of defects 172 where each first defect row 152a is positioned along the first linear path 240a.

Referring still to FIGS. 5B-5D, the process of laser forming linear arrays of defects 150 includes translating at least one of the transparent workpiece 160 and the pulsed laser beam focal line 113 in the second linear direction 102 along a second linear path 240b. As shown in FIG. 5C, the second linear path 240b coincides with a second linear array line 155b such that the pulsed laser beam focal line 113 may irradiate the transparent workpiece 160 along the second linear array line 155b, thereby laser forming the second defect row 152b of at least one linear array of defects 150. The second defect row 152b is adjacent the first defect row 152a and parallel the first defect row 152a. Further, as shown in FIGS. 5B-5D, a single pass of the pulsed laser beam focal line 113 along the second linear path 240b may form multiple second defect rows 152b of multiple linear arrays of defects 150. For example, the second linear path 240b shown in FIG. 5C coincides with two second linear array lines 155b and it should be understood that the second linear path 240b may coincide with any number of second linear array lines 155b such that a single pass of the pulsed laser beam focal line 113 along the second linear path 240b may laser form portions of defects 172 (e.g., second defect rows 152b) of any number of linear arrays of defects 172 where each second defect row 152b is positioned along the second linear path 240b.

Referring still to FIGS. 5B-5D, the process of laser forming linear arrays of defects 150 further includes translating at least one of the transparent workpiece 160 and the pulsed laser beam focal line 113 in the first linear direction 101 along a third linear path 240c. As shown in FIG. 5C, the third linear path 240c coincides with a third linear array line 155c such that the pulsed laser beam focal line 113 may irradiate the transparent workpiece 160 along the third linear array line 155c, thereby laser forming the third defect row 152c of at least one linear array of defects 150. The third defect row 152c is adjacent the second defect row 152b and parallel both the first defect row 152a and the second defect row 152b. Further, as shown in FIGS. 5B-5D, a single pass of the pulsed laser beam focal line 113 along the third linear path 240c may form multiple third defect rows 152c of multiple linear arrays of defects 150. For example, the third linear path 240c shown in FIG. 5C coincides with two third linear array lines 155c and it should be understood that the third linear path 240c may coincide with any number of third linear array lines 155c such that a single pass of the pulsed laser beam focal line 113 along the third linear path 240c may laser form portions of defects 172 (e.g., third defect rows 152c) of any number of linear arrays of defects 172 where each third defect row 152c is positioned along the third linear path 240c.

In some embodiments comprising arrays of linear arrays of defects 150 may be disposed in multiple rows, as depicted in FIGS. 5B-5D may be laser formed by translating the pulsed laser beam focal line 113 in alternating passes in the first linear direction 101 and the second linear direction 102 along linear paths coinciding with portions of multiple linear array lines 155. As an illustrative example, FIG. 5C shows the first linear path 240a spaced apart from the second linear path 240b in an x-direction and the second linear path 240b spaced apart from the third linear path 240c in the x-direction. FIG. 5C also shows a first linear path 240a′, a second linear path 240b′, and a third linear path 240c′ that coincide with portions of additional linear arrays of defects 150. In some embodiments, the pulsed laser beam focal line 113 may be translated in a plurality of alternating passes in the first linear direction 101 and the second linear direction 102 to laser form arrays of linear arrays of defects 150.

Further, the outer linear array lines (e.g., a first linear array line 155a and a third linear array line 155c in the embodiment depicted in FIG. 5B) as well as the ends of inner linear array lines (e.g., the ends of the second linear array line 155b in the embodiment depicted in FIG. 5B) collectively form a desired perimeter of an aperture (e.g., aperture 180) that may be formed in the transparent workpiece 160. Similarly, the linear array of defects 150 comprise a perimeter of defects 154, which comprise the outer defect rows (e.g., a first defect row 152a and a third defect row 152c in the embodiment depicted in FIG. 5D) as well as the end defect of each inner defect row (e.g., the second defect row 152b in the embodiment depicted in FIG. 5D). The perimeter of defects 154 comprise a rectilinear shape, such as a square shape, a rectangular shape, a pentagonal shape, or a hexagonal shape, or other polygonal shape. Further, the perimeter of defects 154 define a desired aperture perimeter along which material of the transparent workpiece 160 may be removed to form an aperture (e.g., the aperture 180) extending through the transparent workpiece 160 upon exposure to the appropriate processing conditions, such as chemical etching. Indeed, in operation, etching the transparent workpiece 160 comprising one or more linear arrays of defects 150 with the a chemical etching solution 202 (FIGS. 6A-6D) may separate a portion of the transparent workpiece 160 that is co-located with the linear array of defects 150 (and outlined by the perimeter of defects 154), thereby forming an aperture 180 (FIG. 6C) extending through the transparent workpiece 160.

Referring again to FIGS. 1A-5C, because the closed contours 170 and the linear arrays of defects 150 are formed by linear translation of at least one of the at least one of the transparent workpiece 160 and the pulsed laser beam focal line 113, the pulsed laser beam 112 may be split, for example, using a beam splitter, allowing two laser beam focal lines 113 to simultaneously irradiate the transparent workpiece 160 at two different locations. By splitting the pulsed laser beam 112, a single linear pass may direct pulsed laser beam focal lines 113 along two linear pathways simultaneously, reducing laser processing time by 50%. In this embodiment, two portions of defects of a closed contour 170 may be formed simultaneously and two defect rows 152 of a linear array of defects 150 may be formed simultaneously. The pulsed laser beam 112 may be split by energy or by frequency.

Referring still to FIGS. 1A-5C, the defects 172 of the closed contour lines 170 and linear arrays of defects 150 may generally be spaced apart from one another by a distance along the closed contour 170 of from 0.1 μm to 500 μm, for example, 1 μm to 200 μm, 2 μm to 100 μm, 5 μm to 20 μm, or the like. For example, suitable spacing between the defects 172 may be from 0.1 μm to 50 μm, such as from 5 μm to 15 μm, from 5 μm to 12 μm, from 7 μm to 15 μm, or from 7 μm to 12 μm. In some embodiments, a spacing between adjacent defects 172 may be 50 μm or less, 45 μm or less, 40 μm or less, 35 μm or less, 30 μm or less, 25 μm or less, 20 μm or less, 15 μm or less, 10 μm or less, or the like. The defects 172 that may penetrate the full depth of the glass. It should be understood that while sometimes described as “holes” or “hole-like,” the defects 172 disclosed herein may generally not be void spaces, but are rather portions of the transparent workpiece 160 which has been modified by laser processing as described herein.

Beyond the perforation of a single transparent workpiece 160, the process may also be used to perforate stacks of transparent workpieces 160, such as stacks of sheets of glass, and may fully perforate glass stacks of up to a few mm total height with a single laser pass. A single glass stack may be comprised of various glass types within the stack, for example one or more layers of soda-lime glass layered with one or more layers of Corning code 2318 glass. The glass stacks additionally may have air gaps in various locations. According to another embodiment, ductile layers such as adhesives may be disposed between the glass stacks. However, the pulsed laser process described herein will still, in a single pass, fully perforate both the upper and lower glass layers of such a stack.

Referring now to FIGS. 6A-6D, following the formation of closed contours 170 and/or linear arrays of defects 150 in the transparent workpiece 160, the transparent workpiece 160 may be chemically etched to separate the transparent workpiece 160 along the closed contour 170 and/or linear arrays of defects 150 to form one or more apertures 180 extending through the transparent workpiece 160. For example, the transparent workpiece 160 may be chemically etched by applying a chemical etching solution 202 comprising a chemical etchant 204 to the transparent workpiece 160, at least along the closed contour 170. Further, when chemical etching is used to separate the transparent workpiece 160 along the closed contour 170 to form the one or more apertures 180 extending through the transparent workpiece 160, it may be desirable to minimize the amount of material removed from the surfaces of the transparent workpiece 160 (i.e. minimizing thickness removal) and to maximize the uniformity of material removal through the depth of each defect 172. This may be achieved by minimizing the etching rate, as described in more detail below.

The defects 172 of the closed contour 170 and/or linear arrays of defects 150 provide a pathway for the chemical etching solution 202 to penetrate into the depth of the transparent workpiece 160 and remove material of the transparent workpiece 160 within and surrounding the defects 172. For example, the chemical etching solution 202 may remove material of the transparent workpiece 160 between adjacent defects 172 along the closed contour 170, thereby separating the material of the transparent workpiece 160 within the closed contour 170 and/or linear arrays of defects 150 from the rest of the transparent workpiece 160 to form the aperture 180. Moreover, because the chemical etching solution 202 may penetrate the thickness of the transparent workpiece 160 via the defects 172, minimal transparent workpiece material must be removed to separate the transparent workpiece 160 along the closed contour 170 and/or linear arrays of defects 150. Thus, the amount of time the transparent workpiece 160 is exposed to the chemical etching solution 202 may be minimized, eliminating the need for a mask to be applied to the transparent workpiece 160 during chemical etching. While a single transparent workpiece 160 is depicted submerged in the chemical etching solution 202 in FIG. 5B, it should be understood that multiple transparent workpieces 160 may be simultaneously chemically etched, for example, in a batch process.

While not intending to be limited by theory, chemically etching the defects 172 of the closed contour 170 and/or linear arrays of defects 150 causes the defects 172 to form an hourglass shaped profile in which a diameter of the defect 172 at the first and second surfaces 162, 164 of the transparent workpiece 160 is greater than a waist diameter within the depth of the defect, (e.g., about halfway between the first and second surfaces 162, 164). This hourglass shaped profile is caused by the initial restriction of the chemical etching solution 202 traversing the depth of the defect 172 (i.e., diffusing through the depth of the defect 172). Thus, the portions of the defects 172 at and near the first and second surfaces 162, 164 will immediately undergo etching when the chemical etching solution 202 contacts the transparent workpiece 160; while portions of the defect 172 within the transparent workpiece 160 will not undergo etching until the chemical etching solution 202 diffuses through the depth of the defects 172 (i.e., diffuses from the first and second surfaces 162, 164 to the waist of the defect 172).

Accordingly, during chemical etching, the diameter of the defect 172 at the first and second surfaces 162, 164 may be larger than the waist diameter of the defect 172. Further, once the chemical etching solution 202 traverses the defect 172 (i.e. reaches the waist/center of the defect 172), the difference between the surface diameters and the waist diameter of each defect 172 will remain constant thereafter. Thus, minimizing the etching rate will minimize the thickness loss of material of the transparent workpiece 160 and the minimize the difference between the surface diameter and the waist diameter of the defects 172 because minimizing the etching rate minimizes the amount of material of the transparent workpiece 160 removed before the chemical etching solution 202 extends through the depth of the transparent workpiece 160. In other words, minimizing the etching rate will maximize the uniformity of material removal through the depth of each defect 172 such that the difference between the diameter of the defect 172 at the major surfaces and the waist diameter of the defect 172 is minimized. Moreover, increasing the uniformity of the defect 172 results in more uniform walls of the aperture 180 formed by release of the closed contour 170 (i.e. aperture walls that are nearly or fully orthogonal to the first and second surfaces 162, 164 of the transparent workpiece 160).

While not intending to be limited by theory, the etching rate is a controllable variable of the Thiele modulus (φ) of a chemical etching process, which mathematically represents a ratio of etching rate to diffusion rate, as described in Thiele, E. W. Relation between catalytic activity and size of particle, Industrial and Engineering Chemistry, 31 (1939), pp. 916-920. While not intending to be limited by theory, when the etching rate is greater than the diffusion time, the Thiele modulus will be greater than 1. This means that the initial chemical etching solution 202 introduced into the defect 172 will be depleted before it reaches the waist (e.g., center) of the defect 172 where it can be replenished by diffusion of additional chemical etchant from the portion of the defect 172 at the opposite surface of the transparent workpiece 160. As a result, chemical etching will begin earlier at the top and bottom of the defects 172 than at the center (e.g., waist), leading to an hourglass-like shape formed from the defect 172. However, if the diffusion time is equal to or greater than the etching rate, then the Thiele modulus will be less than or equal to 1. Under such conditions, the chemical etchant concentration will be uniform along the entire defect 172 and the defect 172 will be etched uniformly, yielding a substantially cylindrical void along each defect 172 and minimizing material removal required to release the transparent workpiece 160 along the closed contour 170 because the voids formed by the chemical etching solution 202 at the defects 172 will join adjacent voids substantially simultaneously along the entire depth of the defects 172, limiting or eliminating removal of excess material at the top and bottom portions of the defects 172.

As described herein, the etching rate can be controlled to control the Thiele modulus of the chemical etching process, and thereby control the ratio of the expansion of the waist diameter of the void formed along the defect 172 to ratio of expansion of the diameters of the top and bottom openings of the void formed from the defect 172. Further, in some embodiments, the Thiele modulus for the chemical etching process described herein can be less than or equal to 5, less than or equal to 4.5, less than or equal to 4, less than or equal to 3.5, less than or equal to 3, less than or equal to 2.5, less than or equal to 2, less than or equal to 1.5, or less than or equal to 1.

Referring still to FIGS. 6A-6D, in some embodiments, the chemical etching solution 202 may remove material from the transparent workpiece 160 at an etching rate of from 0.01 μm per minute (μm/min) to 10 μm/min, for example, 0.05 μm/min, 0.1 μm/min, 0.2 μm/min, 0.3 μm/min, 0.4 μm/min, 0.5 μm/min, 0.6 μm/min, 0.7 μm/min, 0.8 μm/min, 0.9 μm/min, 1 μm/min, 1.1 μm/min, 1.2 μm/min, 1.3 μm/min, 1.4 μm/min, 1.3 μm/min, 1.4 μm/min, 1.5 μm/min, 1.6 μm/min, 1.7 μm/min, 1.8 μm/min, 1.9 μm/min, 2 μm/min, 2.1 μm/min, 2.2 μm/min, 2.3 μm/min, 2.4 μm/min, 2.5 μm/min, 2.6 μm/min, 2.7 μm/min, 2.8 μm/min, 2.9 μm/min, 3 μm/min, 3.5 μm/min, 4 μm/min, 4.5 μm/min, 5 μm/min, 5.5 μm/min, 5.5 μm/min, 6 μm/min, 6.5 μm/min, 7 μm/min, 7.5 μm/min, 8 μm/min, 8.5 μm/min, 9 μm/min, 9.5 μm/min, 10 μm/min, or the like. For example, the etching rate may be 10 μm/min or less, 9 μm/min or less, 8 μm/min or less, 7 μm/min or less, 6 μm/min or less, 5 μm/min or less, 4 μm/min or less, 3 μm/min or less, 2.5 μm/min or less, 2 μm/min or less, 1.5 μm/min or less, 1 μm/min or less, 0.5 μm/min or less, 0.25 μm/min or less, 0.1 μm/min or less, or the like. Further, the etching rate may be from 0 μm/min to 1 μm/min, 0.5 μm/min to 5 μm/min, 1 μm/min to 10 μm/min, or the like.

When the chemical etching solution 202 is applied to the transparent workpiece 160 to release the closed contour 170 and/or linear arrays of defects 150 and remove material of the transparent workpieces 160 thereby forming the apertures 180, the chemical etching solution 202 may remove from between 10 μm and 90 μm of material from the thickness of the transparent workpiece 160, for example, from 35 μm to 85 μm, 50 μm to 80 μm, 60 μm to 80 μm, 70 μm to 85 μm, or the like. Further, when the chemical etching solution 202 is applied to the transparent workpiece 160 to release the closed contour 170 and/or linear arrays of defects 150 and remove material of the transparent workpieces 160 thereby forming the apertures 180, the chemical etching solution 202 may remove 15% or less of a thickness of the transparent workpiece 160, 10% or less of a thickness of the transparent workpiece 160, 7.5% or less of a thickness of the transparent workpiece 160, 5% or less of a thickness of the transparent workpiece 160, 2.5% or less of a thickness of the transparent workpiece 160, or the like.

While not intending to be limited by theory, the etching rate may be lowered by lowering the concentration of chemical etchant 204 of the chemical etching solution 202, lowering the temperature of the chemical etching solution 202, agitating the chemical etching solution 202 during etching, for example, using ultrasonics, physical motion, or the like. Further, the etching rate may be affected by the composition of the transparent workpiece 160. While not intended to be limited by theory, increased alkali content in the transparent workpiece 160 increases the etching rate. For example, given a common chemical etching solution, etching rates for alikali aluminosilicate glass (e.g., Corning Code 2320) are about 2.5 times faster than etching rates of alkaline earth boro aluminosilicate (e.g., EAGLE XG®).

Referring still to FIGS. 6A-6D, the chemical etching solution 202 may be an aqueous solution that includes the chemical etchant 204 and deionized water 208. In some embodiments, the chemical etchant 204 may comprise a primary acid and a secondary acid. The primary acid can be hydrofluoric acid and the secondary acid can be nitric acid, hydrochloric acid, or sulfuric acid. In some embodiments, the chemical etchant 204 may only include a primary acid. In some embodiments, the chemical etchant 204 may include a primary acid other than hydrofluoric acid and/or a secondary acid other than nitric acid, hydrochloric acid, or sulfuric acid. For example, in some embodiments, the primary acid chemical etchant 204 may comprise from 1% by volume hydrofluoric acid to 15% by volume hydrofluoric acid, for example, 2.5% by volume hydrofluoric acid to 10% by volume hydrofluoric acid, 2.5% by volume hydrofluoric acid to 5% by volume hydrofluoric acid, and all ranges and subranges in between. Further, in some embodiments, the secondary acid may comprise may comprise from 1% by volume hydrofluoric acid to 20% by volume nitric acid, for example, 2.5% by volume nitric acid to 15% by volume nitric acid, 2.5% by volume nitric acid to 10% by volume nitric acid, 2.5% by volume nitric acid to 5% by volume nitric acid and all ranges and subranges in between. As additional examples, chemical etchants 204 can include 10% by volume hydrofluoric acid/15% by volume nitric acid, 5% by volume hydrofluoric acid/7.5% by volume nitric acid, 2.5% by volume hydrofluoric acid/3.75% by volume nitric acid, 5% by volume hydrofluoric acid/2.5% by volume nitric acid, 2.5% by volume hydrofluoric acid/5% by volume nitric acid or the like. Further, lowering the concentration of chemical etchant 204 in the chemical etching solution may lower the etching rate. Thus, it may be advantageous to use a minimum effective concentration of chemical etchant 204 in the chemical etching solution 202.

In operation, the etching time required to separate the portion of the transparent workpiece 160 surrounded by the closed contour 170 (or the portion of the transparent workpiece 160 co-located with the linear array of defects 150) from the remaining transparent workpiece 160, thereby forming the aperture 180 in the transparent workpiece 160 may be from 2 mins to 40 mins, for example, 5 mins to 30 mins, 5 mins to 20 mins, 10 mins to 30 mins, 10 mins to 20 mins, 15 mins to 30 mins, or the like. The temperature of the chemical etching solution 202 when etching the transparent workpiece 160 may be from 0 C.° to 40 C.°, for example, 30 C.° or less, 20 C.° or less, 10 C.° or less, 5 C.° or less, or the like. For example, 2 C.°, 5 C.°, 7 C.°, 10 C.°, 12 C.°, 15 C.°, 18 C, 20 C.°, 25 C.°, 30 C.°, 35 C.°, or the like. Further, lowering the temperature of the chemical etching solution 202 when etching the transparent workpiece 160 lowers the etching rate. Thus, colder etching temperatures may be advantageous.

As depicted in FIG. 6B, the chemical etching solution 202 may be housed in a chemical etching bath 200, which may include from 5 L to 15 L of the chemical etching solution 202, for example, 8 L to 10 L. In some embodiments, a larger chemical etching bath 200 and a larger volume of chemical etching solution 202 may be desired to allow more space for motion and agitation. In some embodiments, the chemical etching solution 202 may further comprise a surfactant 206 (FIG. 6D), which increases the wettability of the defects 172 when applied to the transparent workpiece 160. The increased wettability lowers the diffusion time of the chemical etching solution 202 through the depth of each defect 172, which may be desirable as described below. In some embodiments, the surfactant 206 can be any suitable surfactant that dissolves into the chemical etching solution 202 and that does not react with the chemical etchant 204 in the chemical etching solution 202. In some embodiments, the surfactant 206 can be a fluorosurfactant such as Capstone® FS-50 or Capstone® FS-54. In some embodiments, the concentration of the surfactant 206 in terms of ml of surfactant/L, of etching solution can be 1, 1.1, 1.2, 1.3, 1.4, 1.5, 1.6, 1.7, 1.8, 1.9, 2, or greater.

In operation, the transparent workpiece 160 comprising the closed contour 170 and/or linear arrays of defects 150 (or multiple closed contours 170 and/or linear arrays of defects 150 corresponding with multiple desired apertures 180) may be immersed in a chemical etching bath 200 comprising the chemical etching solution 202, as depicted in FIG. 6B. Further, while the chemical etching solution 202 is primarily described herein as an aqueous solution, in some embodiments, the chemical etching solution 202 may comprise a gaseous solution comprising, for example, a vapor HF chemical etchant. In operation, the gaseous chemical etching solution may be applied to the transparent workpiece 160 using a spray etching process. Using a gaseous chemical etching solution may remove the need for an agitation process in order to etch into the depth of the transparent workpiece 160 along the defects 172, as gas may more readily diffuse into the defects 172 than liquid.

While not intending to be limited by theory, forming the closed contour 170 comprising the plurality of defects 172 is a zero or near zero kerf process and thus, when the closed contour 170 is formed in the transparent workpiece 160, it is difficult to separate the material of the transparent workpiece 160 within the closed contour 170 from the rest of the transparent workpiece 160 without damaging the transparent workpiece 160. However, chemically etching the transparent workpiece 160 after forming the closed contour 170 enlarges the defects 172 of the closed contour 170 to release the closed contour 170 and create one or more apertures 180 without unintended damage to the transparent workpiece 160.

In some embodiments, the chemical etching solution 202 may be agitated when the transparent workpiece 160 is positioned within the chemical etching bath 200. For example, the chemical etching solution 202 may be mechanically agitated, ultrasonically agitated, or combinations thereof. Agitation may increase the diffusion rate of the chemical etching solution 202 through the depth of the defects 172, thereby facilitating faster separation while limiting material removal and facilitating uniformly shaped defects 172 (any thereby uniformly shaped aperture walls). In some embodiments, the chemical etching bath 200 may be mechanically agitated in the x, y, and z directions to improve uniform etching of the defects 172. The mechanical agitation in the x, y, and z directions may be continuous or variable. In some embodiments, the chemical etching bath 200 may comprise one or more ultrasonic transducers configured to generate ultrasonic agitation of the chemical etching solution 202 within the chemical etching bath 200. For example, the ultrasonic transducers may be located at the bottom of the chemical etching bath 200 or one or more sides of the chemical etching bath 200.

Further, during ultrasonic agitation, the transparent workpiece 160 may be oriented within the chemical etching bath 200 such that the both ends of each defect 172 (e.g., the portions of the defect 172 located at the first surface 162 and the second surface 164) receive substantially uniform exposure to ultrasonic waves such that the defects 172 of the closed contour 170 are etched uniformly. For example, if the ultrasonic transducers are arranged at the bottom of the chemical etching bath 200, the transparent workpiece 160 can be oriented in the chemical etching bath 200 so that the surfaces of the transparent workpiece 160 between which the defects 172 are perpendicular to the bottom of the chemical etching bath 200 (e.g., face the sides of the chemical etching bath 200) rather than parallel to the bottom of the chemical etching bath 200.

Further, a low etching rate may reduce the formation of optical blemishes. While not intending to be limited by theory, increasing the etching rate increases the rate of formation of insoluble byproducts of the etching process, which may mask portions of the transparent workpiece 160 and cause differential local etching, forming optical blemishes that are visible as streaks on the transparent workpiece. In contrast, lowering the etching rate lowers the rate of formation of insoluble byproducts, allowing the agitation of the chemical etching solution 202 and/or the transparent workpiece 160 to remove the insoluble byproducts from contact with the transparent workpiece 160, reducing the differential local etching caused by these byproducts. Even without agitation, the lowering the rate of formation of insoluble byproducts means a larger portion of the insoluble byproducts will diffuse away from the transparent workpiece 160 before causing the formation of optical blemishes.

Optical blemishes may also be formed when a portion of the transparent workpiece 160 (e.g., a portion within the closed contour 170) that is no longer connected to the remainder of the transparent workpiece 160 adheres to the transparent workpiece 160, for example, when this “disconnected” portion of the transparent workpiece 160 is not yet removed to form the aperture 180. In this situation, the portion of the transparent workpiece 160 that is covered by this disconnected portion receives differential local etching, resulting in optical blemishes. Thus, removing these disconnected portions, for example, using agitation, rotation, or the like may reduce optical blemishes.

In some embodiments, multiple transparent workpieces 160 may be simultaneously etched, for example, by simultaneous immersion in a chemical etching bath 200. However, these multiple transparent workpieces 160 should be oriented and spaced to limit the degree of ultrasonic agitation blocked by the multiple transparent workpieces 160. In other words, the multiple transparent workpieces 160 should be oriented and spaced to maximize the number or transparent workpieces 160 etched at once while retaining desirable levels of agitation.

Further, each aperture 180 comprises an aperture perimeter, which is located at the previous location of individual closed contours 170. In some embodiments, each aperture 180 may comprise a maximum cross-sectional dimension of from 100 μm to 10 mm, for example, 5 mm or less, 3 mm or less, 1 mm or less, 900 μm, 800 μm or less, 700 μm, 600 μm or less, 500 μm or less, 400 μm, 300 μm or less, 250 μm or less, 200 μm or less, 100 μm or less, or the like. In embodiments in which the transparent workpiece 160 comprising the array of apertures 180 comprises non-strengthened glass, edges of each aperture 180 along the aperture perimeter may comprise an edge strength of from 200 MPa to 500 MPa, for example 250 MPa, 300 MPa, 350 MPa, 400 MPa, 450 MPa, or the like. Further, in embodiments in which the transparent workpiece 160 comprising the array of apertures 180 comprises strengthened glass, for example, ion-exchanged glass, edges of each aperture 180 along the aperture perimeter may comprise an edge strength of from 600 MPa to 1000 MPa, for example 650 MPa, 700 MPa, 750 MPa, 800 MPa, 850 MPa, 900 MPa, 950 MPa, or the like. Further, the array of apertures 180 may reduce the strength of the transparent workpiece 160 (when compared to a similar transparent workpiece without apertures) by 30% or less, 20% or less, 10% or less, or the like.

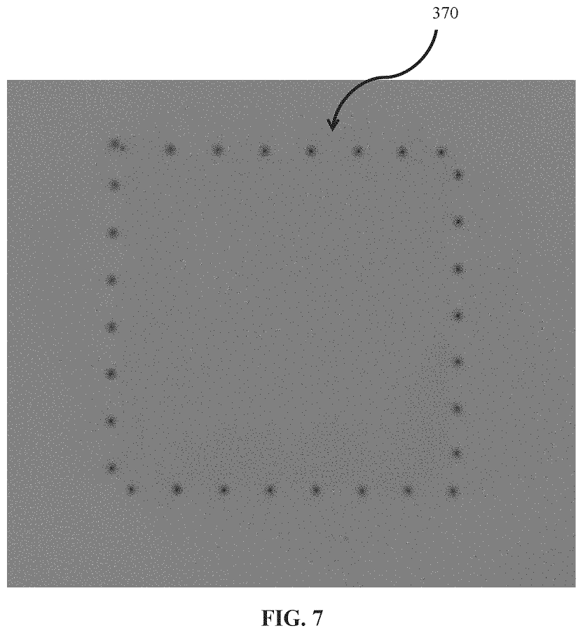

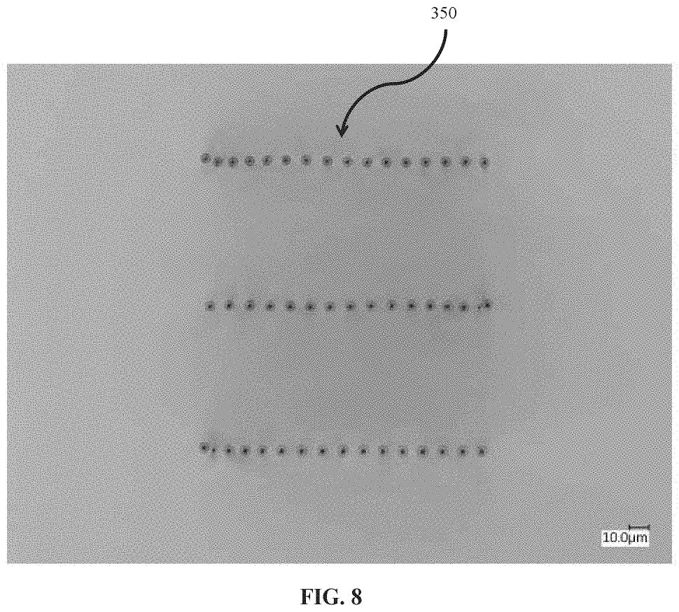

Referring now to FIGS. 7-9, example transparent workpieces are depicted. FIG. 7 shows an example rectilinear closed contour 370 having a square shape, FIG. 8 shows an example linear array of defects 350, and FIG. 9 shows an example transparent workpiece 360 having a plurality of apertures 380, each having a rectilinear shape. The closed contour 170 of FIG. 7 has 30 defects and adjacent defects are spaced apart by 10-20 um. It should be understood that adding additional defects to a closed contour does not increase the laser processing time and may decrease the etching time. Further, the linear array of defects 350 of FIG. 8 includes three defect rows, each 150 μm in length with a row spacing distance of 75 μm. Example defect rows may be 50 μm to 200 μm in length, however, any length is contemplated, for example, when smaller or larger apertures are desired.

Referring now to FIGS. 1-9, the transparent workpieces 160, 360 (FIGS. 6C and 9) described herein that comprise apertures 180, 380 may be part of a transparent workpiece assembly, which may comprise a single transparent workpiece 160, 360 having apertures, 180, 380 or may comprise multiple transparent workpieces, at least one of which comprises apertures 180, 380. As one example, the transparent workpiece assembly comprises a transparent workpiece 160 having a first surface 162 opposite a second surface 164 and an array of apertures 180 extending from the first surface 162 to the second surface 164. Each of the apertures 180 of the array of apertures 180 comprise a rectilinear shape (e.g., a square shape as shown in FIG. 6C) and adjacent apertures 180 of the array of apertures 180 are spaced apart by an aperture spacing distance of from 0.1 mm to 5 mm. In some embodiments, the array of apertures 180 comprise 50 apertures or more, for example, 100 apertures or more, 250 apertures or more, 500 apertures or more, 1000 apertures or more, or 5000 apertures or more. In addition, the transparent workpiece assembly may comprise a second transparent workpiece coupled to the first surface 162 or the second surface 164 of the transparent workpiece 160. The second transparent workpiece may be free of apertures and may be thicker than the transparent workpiece 160, 360. In some embodiments, the transparent workpiece assembly may be an acoustic panel assembly, which may be used in an architectural application, for example, disposed within the walls of a building to provide sound absorbing functionality.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method for processing a transparent workpiece, the method comprising:
forming a closed contour in the transparent workpiece, wherein the closed contour comprises a plurality of defects in the transparent workpiece, the closed contour comprises a rectilinear shape, and forming the closed contour comprises:
directing a pulsed laser beam oriented along a beam pathway and output by a beam source through an aspheric optical element and into the transparent workpiece such that a portion of the pulsed laser beam directed into the transparent workpiece generates an induced absorption within the transparent workpiece, the induced absorption producing a defect within the transparent workpiece, and the portion of the pulsed laser beam directed into the transparent workpiece comprises a pulsed laser beam focal line comprising a quasi-non-diffracting beam;
translating at least one of the transparent workpiece and the pulsed laser beam focal line relative to each other along a closed contour line comprising the rectilinear shape, thereby laser forming the plurality of defects of the closed contour along the closed contour line within the transparent workpiece; and
etching the transparent workpiece with a chemical etching solution to separate a portion of the transparent workpiece along the closed contour, thereby forming an aperture extending through the transparent workpiece.

2. The method of claim 1, wherein the rectilinear shape of the closed contour is a square shape, a rectangular shape, a pentagonal shape, or a hexagonal shape.

3. The method of claim 1, wherein translating at least one of the transparent workpiece and the pulsed laser beam focal line relative to each other along the closed contour line comprises:
translating at least one of the transparent workpiece and the pulsed laser beam focal line in a first linear direction along a first linear path that coincides with a first portion of the closed contour line, thereby laser forming a first portion of defects of the closed contour; and
translating at least one of the transparent workpiece and the pulsed laser beam focal line in a second linear direction along a second linear path that coincides with a second portion of the closed contour line, thereby laser forming a second portion of defects of the closed contour, wherein the first linear direction is opposite the second linear direction.

4. The method of claim 3, wherein:
translating at least one of the transparent workpiece and the pulsed laser beam focal line in the first linear direction along the first linear path laser forms a plurality of first portions of defects of a plurality of closed contours; and
translating at least one of the transparent workpiece and the pulsed laser beam focal line in the second linear direction along the second linear path laser forms a plurality of second portions of defects of the plurality of closed contours.

5. The method of claim 3, wherein translating at least one of the transparent workpiece and the pulsed laser beam focal line relative to each other along the closed contour line comprises:
translating at least one of the transparent workpiece and the pulsed laser beam focal line in a third linear direction along a third linear path that coincides with a third portion of the closed contour line, thereby laser forming a third portion of defects of the closed contour; and
translating at least one of the transparent workpiece and the pulsed laser beam focal line in a fourth linear direction along a fourth linear path that coincides with a fourth portion of the closed contour line, thereby laser forming a fourth portion of defects of the closed contour.

6. The method of claim 5, wherein the fourth linear direction is opposite the third linear direction.

7. The method of claim 5, wherein the first linear path and the second linear path are each orthogonal the third linear path and the fourth linear path.

8. The method of claim 5, wherein:
the third linear direction is the same as the first linear direction;
the fourth linear direction is the same as the second linear direction; and
the method further comprises rotating the transparent workpiece before laser forming the third portion of defects and the fourth portion of defects of the closed contour.

9. The method of claim 5, wherein;
translating at least one of the transparent workpiece and the pulsed laser beam focal line in the third linear direction along the third linear path laser forms a plurality of third portions of defects of a plurality of closed contours; and
translating at least one of the transparent workpiece and the pulsed laser beam focal line in the fourth linear direction along the fourth linear path laser forms a plurality of fourth portions of defects of the plurality of closed contours.

10. The method of claim 1, wherein the aperture comprises an aperture perimeter having a maximum cross sectional dimension of 100 μm to 10 mm.

11. The method of claim 1, wherein the chemical etching solution etches the transparent workpiece at an etching rate of 10 μm/min or less.

12. The method of claim 1, wherein etching the transparent workpiece removes 15% or less of a thickness of the transparent workpiece.

13. The method of claim 1, wherein the chemical etching solution comprises a chemical etchant that comprises hydrofluoric acid, nitric acid, hydrochloric acid, sulfuric acid, or combinations thereof.

14. The method of claim 1, wherein a spacing between adjacent defects is 30 μm or less.

15. The method of claim 1, wherein the quasi-non-diffracting beam comprises:
a wavelength λ;
a spot size wₒ; and
a Rayleigh range Z_{R} that is greater than
$${F}_{D} \frac{π {w}_{0}^{2}}{λ} ,$$
where F_{D} is a dimensionless divergence factor comprising a value of 10 or greater.

16. The method of claim 15, wherein:
the dimensionless divergence factor F_{D} comprises a value of from 10 to 2000;
the pulsed laser beam has a wavelength λ and wherein the transparent workpiece has combined losses due to linear absorption and scattering less than 20%/mm in a beam propagation direction; and
the beam source comprises a pulsed beam source that produces pulse bursts with from 2 sub-pulses per pulse burst to 30 sub-pulses per pulse burst and a pulse burst energy is from 100 μJ to 600 μJ per pulse burst.

17. The method of claim 1, further comprising forming a plurality of closed contours in the transparent workpiece using the pulsed laser beam and etching the transparent workpiece with the chemical etching solution to separate portions of the transparent workpiece along the plurality of closed contours, thereby forming a plurality of apertures each extending through the transparent workpiece.

18. The method of claim 17, wherein adjacent apertures of the plurality of apertures are spaced apart by an aperture spacing distance of from 0.1 to 5 mm.

19. A method for processing a transparent workpiece, the method comprising:
forming a linear array of defects in the transparent workpiece, wherein forming the linear array of defects comprises:
directing a pulsed laser beam oriented along a beam pathway and output by a beam source through an aspheric optical element and into the transparent workpiece such that a portion of the pulsed laser beam directed into the transparent workpiece generates an induced absorption within the transparent workpiece, the induced absorption producing a defect within the transparent workpiece, and the portion of the pulsed laser beam directed into the transparent workpiece comprises a pulsed laser beam focal line comprising a quasi-non-diffracting beam;
translating at least one of the transparent workpiece and the pulsed laser beam focal line relative to each other in a first linear direction along a first linear path, thereby laser forming a first defect row of the linear array of defects;
translating at least one of the transparent workpiece and the pulsed laser beam focal line relative to each other in a second linear direction along a second linear path, opposite the first linear direction, thereby laser forming a second defect row of the linear array of defects adjacent the first defect row; and
translating at least one of the transparent workpiece and the pulsed laser beam focal line relative to each other in the first linear direction along a third linear path, thereby laser forming a third defect row of the linear array of defects adjacent the second defect row;
etching the transparent workpiece with a chemical etching solution to separate a portion of the transparent workpiece that is co-located with the linear array of defects, thereby forming an aperture extending through the transparent workpiece.

20. The method of claim 19, wherein:
each defect row of the linear array of defects are parallel to one another, and
adjacent defect rows of the linear array of defects are spaced apart by a row spacing distance of 100 μm or less.
